(19) United States
(12) Patent Application Publication
(10) Pub. No.: US 2023/0175883 A1
(43) Pub. Date: Jun. 8, 2023

(54) METHOD FOR MEASURING NOISE AND APPARATUS FOR NOISE MEASUREMENT

(71) Applicant: AEROMON OY, Helsinki (FI)

(72) Inventors: Jani YLI-ALHO, Helsinki (FI); Matti IRJALA, Helsinki (FI); Tuomas RANTALA, Helsinki (FI)

(21) Appl. No.: 17/921,127

(22) PCT Filed: Apr. 28, 2021
(86) PCT No.: PCT/FI2021/050314

§ 371 Date: Oct. 25, 2022

(30) Foreign Application Priority Data
Apr. 29, 2020 (FI) 20205436

(51) Int. Cl. G01H 3/12; B64C 39/02; B64U 20/80; B64U 50/13; B64U 30/299

(52) U.S. Cl. CPC G01H 3/12; B64C 39/024; B64U 20/80; B64U 30/299; B64U 50/13; B64U 2101/00

(57) ABSTRACT

A method for measuring noise is disclosed. The method includes a sound pressure measurement step for measuring sound pressure information from a noise source with a sound pressure sensor. The method further includes a distance determination step for determining distance determinant information indicative of distance between the noise source and the sound pressure sensor. The sound pressure measurement step and the distance determination step are executed in an unmanned aerial measurement apparatus. The unmanned aerial measurement apparatus includes an unmanned aerial vehicle. The method includes controlling flight of the unmanned aerial measurement apparatus. A related unmanned aerial measurement apparatus is also disclosed.

### FIELD OF THE INVENTION

The present invention relates to a method for measuring noise, and more particularly to method according to preamble of claim 1. The present invention further relates to an apparatus for noise measurement, and more particularly to an apparatus according to preamble of claim 15.

### BACKGROUND OF THE INVENTION

Acoustic noise can be defined as any unwanted, unpleasant, disturbing or harmful sound, detected by the sense of sound. Acoustic noise, referred to as simply “noise” in this application, is present in human environments so much that a term “noise pollution” has been coined. Noise pollution is also called environmental noise or sound pollution. Noise pollution is the presence of noise in the environment with harmful impact on human or animal life. World Health Organization (WHO) categorizes noise pollution currently as one of the most severe environmental, global health problems, second only to small particle emissions. Noise induced health issues include cardiovascular diseases, sleeping disorders and depression.

Sources of noise pollution include motor vehicles, aircraft, trains and many industrial sources. For each of these noise sources, there are a variety of ways to reduce sound levels, for example by reducing the intensity of the noise sources, by planning zoning and land-use with noise pollution in mind, by introducing noise barriers and baffles, by regulating the timing of noise emissions, by controlling vehicle routing and by improving construction and architecture in terms of noise control and attenuation.

Based on the WHO studies, sound levels less than 70 dBA are not damaging to living organisms, regardless of exposure time. On the other hand, exposure for more than 8 hours to constant noise above 85 dBA is likely dangerous to health in many ways. Thus, it is important to understand the quantitative values of noise and noise pollution present in the environment. Many environmental regulations, abatement rules and laws exist to control and limit allowable noise levels.

Level of noise is traditionally measured with a sound level meter. Such devices are readily commercially available in portable and battery-operated versions. In locations with a human access, noise monitoring with a portable device is straightforward. On the other hand, permanent and semi-permanent noise monitoring stations are also available for use cases warranting a permanent, fixed noise monitoring like with airport noise, construction noise, mining noise and traffic noise. Standards exist to harmonise the functionality, methodology and performance of sound level meters (for example IEC 61672-1:2013) to arrive in a meaningful and comparable set of results for noise pollution analyses and regulation conformance.

One of the most challenging noise monitoring cases relates to the noise emissions from smokestacks or chimneys, which are high-rising ventilation structures that emit and disperse often hot and toxic exhaust gases, vapours, smoke and other particulates produced by burning or other chemical processes. With chimneys, primary noise source is the aperture or mouth at the upper or top end of the chimney where the flux of the exhaust hits the surrounding atmosphere, generating a violent, turbulent flow regime and, consequently, a major source of noise. The mouth of the chimney can reside at a height of hundreds of meters, ejecting a potentially hot, toxic and chemically highly reactive flux of fluids into the nearby environment and simultaneously giving rise to very high noise levels.

In the prior art, noise emission measurements and analysis from the mouths of chimneys has been realized with elevators, cranes or lifts, carrying the noise level meter nearby the chimney mouth from the base level. For chimneys higher than 50 meters, using a mobile lifting device like a crane car becomes difficult and dangerous as for example wind conditions high above the ground can cause the crane to fail and fall down. Finding a suitable and accessible spot for the crane car near the chimney base can turn out to be impossible in a crowded industrial area, having no foresight in the design for a need of such a noise measurement event. If the side of the chimney is provided with a ladder, a climber with a portable noise monitoring unit can climb to the chimney mouth. With an operating, high chimney, such a climb is clearly a hazardous undertaking. Finally, some chimneys are simply too high for any land-based mobile lifting solution or climber to realistically reach the chimney top. Another prior art solution is to equip the mouth area of the chimney with a fixed sound level monitoring station. Such solutions are expensive, very difficult to maintain and prone to wear, corrosion and various chemical reactions caused or intensified by the constantly flowing flux of chimney’s emissions.

Naturally, chimneys are not the only hard-to-reach locations for acoustic noise level measurements. Air conditioning units can be installed in the middle of the roofing structures of high-rise building roofs, but still requiring noise level control. Wind turbines for electrical power generation have a very complex noise generating shape due to their rotating parts, most of which is also located high above ground. Cranes and other lifting devices have been used in the prior art for these noise measurement cases, with only a modest degree of success.

Noise measurement from an unmanned aerial vehicle, also called a UAV or a drone, is also known in prior art. With remote controls it is straightforward to fly a drone into the vicinity of an elevated or otherwise hard-to-reach outdoor noise source. Drones capable of hovering flight are available commercially at affordable consumer prices, also with a lifting capability to carry a sound level meter with a memory for measurement result storage. However, a simple combination of a drone and a sound level meter for remote noise level measurements is faced with at least two problems:

As the first problem, an airborne sound level meter equipped drone generates a considerable level of noise of its own, transmitted to the integrated sound level meter through the attachment points and through the air surrounding and suspending the drone. It is difficult to separate this intrinsic noise (noise generated by the drone in operation) from the actual noise or source noise to be measured.

Second problem stems from the inverse square law nature of sound energy dispersion from a point-like noise source. To make the noise measurement more reliable over the intrinsic noise of the operating drone, it is straightforward to perform the measurements close to the noise source. As the noise level L of a point-like noise source follows inverse square law in terms of the distance r, that is, L ~ 1/r², it is clear that the closer the measurement is performed, the higher level of noise is obtained, thus dominating over the intrinsic noise of the drone. Due to this distance dependency, many standards specify the measurement position and distance to the noise source very accurately. For example, standard DIN45635 part 47, relating to the determination of noise emitted by a mouth of a chimney, specifies that the measurement distance to the outer rim of the cylindrically symmetric chimney mouth is 1 m. However, at distance of 1.0 m from the chimney mouth outer rim, movement to a distance of 1.1 m (movement of only 10 cm) causes a 0.83 dB change into the sound level measurement results, again assuming a point-like noise source. Similar change in distance at 5.0 m to 5.1 m (again movement of only 10 cm, but further away from the noise source) is only 0.17 dB. But at this distance of 5.0 m, the first problem of intrinsic noise starts to dominate again. In other words, the intrinsic noise level of the drone is too high vs. the noise from the noise source. Thus, the related prior art problems can be summarized as follows:
i) It is difficult (risky, expensive and time-consuming) to position the sound level meter close enough to the noise source in many elevated noise measurement situations with any ground based lifting devices, crane devices or climbers.
ii) If drones are used, the drone-carried sound level meter has to be flown very close to the noise source to overcome the intrinsic noise generated by the drone itself, and many existing standards also stipulate a close measurement distance to the noise source,
iii) However, in close distances to the noise source, even a small variation to the measurement distance hampers the measurement result unusable, or at least considerably increases its uncertainty. It is difficult to achieve a small variation in a measurement distance with a drone hovering high above the ground, especially if the drone is close to fringes of strong chimney exhausts or rotating wind turbine blades or in gusty winds that are unfortunately prevalent high above the ground.

Thus, there is a need for an improved noise measurement or analysis method and apparatus that solves the problems of the prior art.

### BRIEF DESCRIPTION OF THE INVENTION

An object of the present invention is to provide method for measuring noise and an apparatus for measuring noise so that the prior art disadvantages are solved or at least alleviated. The objects of the invention are achieved by a method for measuring noise according to the independent claim 1. The objects of the present invention are further achieved by an unmanned aerial measurement apparatus according to the independent claim 15.

The preferred embodiments of the invention are disclosed in the dependent claims.

An advantage of the invention is that by performing the noise measurements from an unmanned aerial measurement apparatus, hard-to-reach noise sources like chimneys can be measured. By determining the distance of the measurement of the sound level information between the measurement unit and the noise source, measurement errors caused by the variations in measurement distances may be considerably reduced.

As an aspect of the invention, a method for measuring noise is disclosed. The method comprises a sound pressure measurement step for measuring sound pressure information from a noise source with a sound pressure sensor. The method further comprises a distance determination step for determining distance determinant information indicative of distance between the noise source and the sound pressure sensor. The sound pressure measurement step and the distance determination step are executed in an unmanned aerial measurement apparatus, the unmanned aerial measurement apparatus comprising an unmanned aerial vehicle, and the method comprises controlling flight of the unmanned aerial measurement apparatus. With the distance related information, it is possible to make sound pressure measurement more accurate especially when the sound pressure sensor is not stationary but moves, especially with wind or with another random events. An unmanned aerial measurement apparatus makes it possible to reach difficult locations for noise measurements, for example chimney exhaust openings. Distance determinant information is any information that may contribute in the determination of distance between the sound pressure sensor and the noise source.

In an embodiment, controlling flight of the unmanned aerial measurement apparatus is performed such that the unmanned aerial measurement apparatus flies in the proximity of the noise source.

In an embodiment, controlling flight of the unmanned aerial measurement apparatus is performed such that the unmanned aerial measurement apparatus flies in the proximity of the noise source such that the shortest distance between the sound pressure sensor and the noise source is 0.1 m - 8 m, more preferably 0.5 m - 4 m and most preferably 0.7 m - 1.5 m, for example 1.0 m.

In an embodiment, the distance determinant information comprises sound pressure sensor position information, and the distance determination step comprises a sound pressure sensor position determination step for determining the sound pressure sensor position information. Sound pressure sensor position information can be used to determine the distance to the noise source.

For example, it is possible to provide a 2D or 3D precomputed computational map or table that, for each sound pressure sensor position, provides the distance between the noise source and the sound pressure sensor, or provides other digital data based on the distance, like compensation, or specifically, a compensation multiplier to be used in a compensation step.

In an embodiment, the method further comprises a noise source position determination step for determining noise source position information, and the distance determinant information comprises distance information, and the distance determination step comprises a distance computation step for computing the distance information from the sound pressure sensor position information and from the noise source position information. With the information on noise source position and sound pressure sensor position, distance between the two is obtained. The position herein means may mean a two- or three-dimensional position, for example longitude and latitude, or longitude, latitude and altitude, or an XY or an XYZ position relative to some frame of reference and origin.

In an embodiment, the sound pressure sensor position determination step is executed utilizing information from a satellite positioning system receiver; or the sound pressure sensor position determination step is executed utilizing information from an inertial positioning system; or the sound pressure sensor position determination step is executed utilizing information from a satellite positioning system receiver and an inertial positioning system; or the sound pressure sensor position determination step is executed utilizing information from a satellite positioning system receiver augmented with information from a barometric positioning unit; or the sound pressure sensor position determination step is executed utilizing information from an inertial positioning system augmented with information from a barometric positioning unit; or the sound pressure sensor position determination step is executed utilizing information from a satellite positioning system receiver and information from inertial positioning system, information from a satellite positioning system receiver and information from inertial positioning system both augmented with information from a barometric positioning unit. These are advantageous ways for a position-based distance determination. With information from barometric positioning unit, also altitude (Z) information becomes available, or it becomes more accurate.

In an embodiment, the method further comprises: a position related data storage step for storing the sound pressure information and the sound pressure sensor position information to a memory; or a position related transmission step where the sound pressure information and the sound pressure sensor position information are transmitted with a transceiver to a remote-control unit or to a measurement information reception unit; or both a position related data storage step for storing the sound pressure information and the sound pressure sensor position information to a memory and a position related transmission step where the sound pressure information and the sound pressure sensor position information are transmitted with a transceiver to a remote-control unit or to a measurement information reception unit. With this measurement information, it is possible to determine the measurement result after the measurement event.

In an embodiment, the distance determinant information comprises distance information and the distance determination step comprises a distance measurement step generating the distance information wherein the distance information between the sound pressure sensor and the noise source is measured by utilizing information from any of the following sensors:
an ultrasound sensor,
a laser sensor,
a LIDAR sensor,
a external distance measurement sensor,
a camera sensor,
an infrared sensor,
a microwave radar sensor, or
a millimeter wave radar sensor.

Measuring distance directly as distance information is another way to determine the distance between the sound pressure sensor and the noise source efficiently.

In an embodiment, in the method further comprises: a distance related data storage step where the sound pressure information and the distance information are stored to a memory; or a distance related transmission step where the sound pressure information and the distance information are transmitted with a transceiver to a remote-control unit or to a measurement information reception unit; or both. With this measurement information, it is also possible to determine the measurement result after the measurement event.

In an embodiment, the sound pressure measurement step is executed in the sound pressure sensor and the distance determination step is executed in a distance determination unit such that the sound pressure sensor and the distance determination unit are arranged according to the apparatus aspect and its embodiments of the present invention. These are advantageous arrangements for the distance determination unit and the sound pressure sensor in the unmanned aerial measurement apparatus.

In an embodiment, the method comprises more than one sound pressure measurement steps and more than one distance determination steps. With many measurement needs, information from various distances is necessitated. It is also possible to compensate and time-average the sound pressure measurement results with multiple data points, making them more accurate in the process.

In an embodiment,
the sound pressure measurement step is executed at the rate of 10 kHz
   100 kHz, and the distance determination step is executed at the rate of 1 Hz -50 Hz; or
the sound pressure measurement step is executed at the rate of 10 kHz
   100 kHz, and the distance determination step is executed at the rate of 50 Hz -500 Hz; or
the sound pressure measurement step is executed at the rate of 10 kHz
   100 kHz, and the distance determination step is executed at the rate of 500 Hz -5 kHz. With suitable measurement frequencies, reliable results are obtained without excessive utilisation of computational resources.

In an embodiment, the method further comprises an acceptance determination step in which the sound pressure information is accepted if the distance between the noise source and the sound pressure sensor is between a range of a minimum allowable distance and a maximum allowable distance during the sound pressure measurement step, and discarded if the distance between the noise source and the sound pressure sensor is outside a range of a minimum allowable distance and a maximum allowable distance during the sound pressure measurement step. By controlling the distance variation like this, sound pressure measurements related to a noise source become more accurate. This is because the error caused by the distance variation during the measurement is diminished.

In an embodiment, the method further comprises a triggering step that executes the sound pressure measurement step when the distance between the noise source and the sound pressure sensor is between a range of a minimum allowable distance and a maximum allowable distance, and leaves the sound pressure measurement step unexecuted when the distance between the noise source and the sound pressure sensor is outside a range of a minimum allowable distance and a maximum allowable distance. By controlling the distance variation like this, sound pressure measurements related to a noise source become more accurate. This is because the error caused by the distance variation during the measurement is diminished.

In an embodiment, the method further comprises a compensation step for compensating the sound pressure information with a compensation model, compensation being based on the distance determinant information indicative of the distance between the noise source and the sound pressure sensor. By compensating the sound pressure information with distance-based compensation computations, for example with the inverse square law, the sound pressure measurements become more accurate as compensation diminishes the error caused by the distance variation during the measurement.

In an embodiment, the method further comprises: a time-averaging step after the compensation step wherein the sound pressure information is time averaged after the compensation step; or a weighting step after the compensation step wherein the sound pressure information is weighted after the compensation step; or a time-averaging step before the compensation step wherein the sound pressure information is time averaged before the compensation step; or a weighting step before the compensation step wherein the sound pressure information is weighted before the compensation step. With variable measuring conditions, time-averaging of the sound pressure information yields more a consistent and comparable result than a single, point-in-time type of result. Weighting of the sound pressure information may give a better indication of the noise level vis-a-vis the sense of hearing.

As another aspect of the present invention, an unmanned aerial measurement apparatus for noise measurement from a noise source is disclosed. The unmanned aerial measurement apparatus comprises an unmanned aerial vehicle, a sound pressure sensor configured to measure sound pressure information from a noise source, and a distance determination unit configured to determine distance determinant information indicative of distance between the noise source and the sound pressure sensor. With the distance related information, it is possible, for example, to make sound pressure measurement more accurate especially when the sound pressure sensor is not stationary but moves, especially with wind or with another random events. An unmanned aerial measurement apparatus makes it possible to reach difficult locations for noise measurements, for example chimney exhaust openings. Distance determinant information is any information that may contribute in the determination of distance between the sound pressure sensor and the noise source.

In an embodiment, the sound pressure sensor and the distance determination unit are arranged as an embedded unit into the unmanned aerial vehicle. This embodiment is advantageous especially if the unmanned aerial vehicle comprises a satellite positioning system receiver or an inertial positioning system, or both, as the data it provides may be used directly for a position based distance determination. The unmanned aerial vehicle may also comprise an arm to which the sound pressure sensor may be arranged to distance the sound pressure sensor from the humming, disturbing noise produced by the unmanned aerial vehicle during flight that may cause measurement errors.

In an embodiment, the sound pressure sensor and the distance determination unit are arranged into a mission unit comprising a coupler to couple the mission unit to the unmanned aerial vehicle. A mission unit may be advantageous to make an aerodynamic, easy to attach product.

In an embodiment, the unmanned aerial vehicle comprises propellers, the unmanned aerial measurement apparatus comprises an appendage arranged to provide separation from the propellers of the unmanned aerial vehicle, and the appendage is connected to the unmanned aerial vehicle, and the sound pressure sensor is connected to the appendage such that the sound pressure sensor is separated from the propellers of the unmanned aerial vehicle with the appendage.

In an embodiment, the unmanned aerial vehicle comprises propellers, the unmanned aerial measurement apparatus comprises an appendage arranged to provide separation from the propellers of the unmanned aerial vehicle, and the appendage is connected to the unmanned aerial vehicle, and the sound pressure sensor is connected to the appendage such that a closest separation between each of the propellers of the unmanned aerial vehicle and the sound pressure sensor is at least 10 cm.

In an embodiment, the unmanned aerial vehicle comprises propellers, the unmanned aerial measurement apparatus comprises an appendage arranged to provide separation from the propellers of the unmanned aerial vehicle, and the appendage is connected to the unmanned aerial vehicle, and the sound pressure sensor is connected to the appendage such that the sound pressure sensor is located outside the area of downwash of the propellers.

In an embodiment, the unmanned aerial vehicle comprises propellers, the unmanned aerial measurement apparatus comprises one or more appendages arranged to provide separation from the propellers of the unmanned aerial vehicle, the one or more appendages being connected to the unmanned aerial vehicle, the sound pressure sensor and the distance determination unit being connected to the one or more appendages, and the sound pressure sensor and the distance determination unit are separated from the propellers of the unmanned aerial vehicle with the one or more appendages.

In an embodiment, the unmanned aerial vehicle comprises propellers, the unmanned aerial measurement apparatus comprises one or more appendages arranged to provide separation from the propellers of the unmanned aerial vehicle, the one or more appendages being connected to the unmanned aerial vehicle, the sound pressure sensor and the distance determination unit being connected to the one or more appendages, and the sound pressure sensor and the distance determination unit are separated from the propellers of the unmanned aerial vehicle with the one or more appendages such that a closest separation between each of the propellers of the unmanned aerial vehicle and the sound pressure sensor is at least 10 cm, and a closest separation between each of the propellers of the unmanned aerial vehicle and the distance determination unit is at least 10 cm.

In an embodiment, the unmanned aerial vehicle comprises propellers, the unmanned aerial measurement apparatus comprises one or more appendages arranged to provide separation from the propellers of the unmanned aerial vehicle, the one or more appendages being connected to the unmanned aerial vehicle, the sound pressure sensor and the distance determination unit being connected to the one or more appendages, and the sound pressure sensor and the distance determination unit are separated from the propellers of the unmanned aerial vehicle with the one or more appendages such that the sound pressure sensor is located outside the area of downwash of the propellers, and the distance determination unit is located outside the area of downwash of the propellers.

In an embodiment, the appendage comprises a longitudinal arm.

In an embodiment, the appendage comprises a propeller guard.

In an embodiment, the appendage comprises both a longitudinal arm and a propeller guard.

These are advantageous embodiments for arranging separation between the distance determination unit and the noise-generating propellers of the unmanned aerial vehicle to diminish the measurement error caused by the noise of the propellers.

Especially an ultrasound sensor configured to measure the distance information between the noise source and the sound pressure sensor may be disturbed by the noise of the propellers.

In an embodiment, the distance determinant information comprises sound pressure sensor position information, and the distance determination unit comprises:
a satellite positioning system receiver configured to determine the sound pressure sensor position information of the sound pressure sensor; or
an inertial positioning system configured to determine the sound pressure sensor position information of the sound pressure sensor; or
both a satellite positioning system receiver and an inertial positioning system configured to determine the sound pressure sensor position information of the sound pressure sensor. Sound pressure sensor position can be used to determine the distance to the noise source, from a satellite positioning system receiver or from an inertial positioning system, or both.

In an embodiment, the distance determinant information comprises sound pressure sensor position information and the distance determination unit comprises:

a satellite positioning system receiver configured to determine the sound pressure sensor position information of the sound pressure sensor, and a barometric positioning unit configured to augment the sound pressure sensor position information; or
an inertial positioning system configured to determine the sound pressure sensor position information of the sound pressure sensor, and a barometric positioning unit configured to augment the sound pressure sensor position information; or
both a satellite positioning system receiver and an inertial positioning system configured to determine the sound pressure sensor position information of the sound pressure sensor, and a barometric positioning unit configured to augment the sound pressure sensor position information. These are advantageous ways for a position based distance determination. With information from barometric positioning unit, also altitude (Z) information becomes available or it can be made more accurate.

In an embodiment, the distance determinant information comprises distance information and the distance determination unit comprises a laser sensor, a LIDAR sensor, an external distance measurement sensor, a camera sensor, an infrared sensor, a microwave radar sensor, or a millimeter wave radar sensor configured to measure the distance information between the noise source and the sound pressure sensor. Devices arranged to measure the distance directly as distance information is another way to determine the distance directly between the sound pressure sensor and the noise source efficiently.

In an embodiment, the distance determinant information comprises distance information and the distance determination unit comprises an ultrasound sensor configured to measure the distance information between the noise source and the sound pressure sensor. An ultrasound sensor is advantageous for measuring the distance information between the noise source and the sound pressure sensor when noise source is arranged to emit exhausts that disturb optical or radio wave based sensors such as laser sensors, LIDAR sensors, camera sensors, infrared sensors or radar sensors. A chimney exhaust opening is an example of a noise source which is arranged to emit exhausts.

In an embodiment, measurement information comprises the sound pressure information and the distance determinant information and the unmanned aerial measurement apparatus further comprises:
a transceiver for transmitting the measurement information to a remote-control unit; or
a transceiver for transmitting the measurement information to a measurement information reception unit; or
a memory for storing the measurement information; or
any combination thereof.

Invention has many advantages. In particular, noise can be measured from hard-to-reach places. By determining the distance to the noise source in conjunction with the sound pressure measurement from the noise source, it is also possible to use the distance to make the noise measurements more accurate.

For the purposes of this text, “unmanned aerial vehicle” and “drone” both mean a vehicle that is capable of hovering and slow flight and, can be controlled remotely (unmanned) and is capable of carrying payload, for example one or more measurement units.

For the purposes of this text, sound pressure information and distance related information (for example distance determinant information, distance information and sound pressure position information) are associated such that the method and apparatus and their embodiments disclosed herein may use sound pressure information and distance related information in a sensible combination.

A configuration for associating the sound pressure information and the distance related information is, for example, a time index that determines which piece of distance related information is associated with a certain piece of sound pressure information.

### BRIEF DESCRIPTION OF THE DRAWINGS

The invention is described in detail by means of specific embodiments with reference to the enclosed drawings, in which

FIG. 1 shows schematically a block diagram of a prior art apparatus and method of measuring sound pressure information related to noise;

FIG. 2a shows a block diagram of an apparatus and method according to an embodiment of the invention;

FIG. 2b shows a block diagram of an apparatus and method according to an embodiment of the invention where distance is determined directly with measurements;

FIG. 2c shows a block diagram of an apparatus and method according to another embodiment of the invention where distance is determined directly with measurements;

FIG. 3 shows a block diagram of an apparatus and method according to an embodiment of the invention where distance is determined indirectly;

FIG. 4 shows a block diagram of an apparatus and method according to another embodiment of the invention where distance is determined indirectly;

FIGS. 5-7f show block diagrams of an apparatus and method according to an embodiment of the invention related to the positioning of the various units;

FIG. 8 shows a block diagram of a computer that may perform the method steps of the embodiments of the invention and implement units of the embodiments of the apparatus;

FIG. 9 shows another measurement event related to embodiments of the invention;

FIG. 10 shows another measurement event related to embodiments of the invention, now related to the compensation; and

FIG. 11 shows a block diagram of an apparatus and method according to another embodiment of the invention where distance is determined indirectly and analysed in a computing unit.

### DETAILED DESCRIPTION OF THE INVENTION

In the following description, like numbers or labels denote like elements.

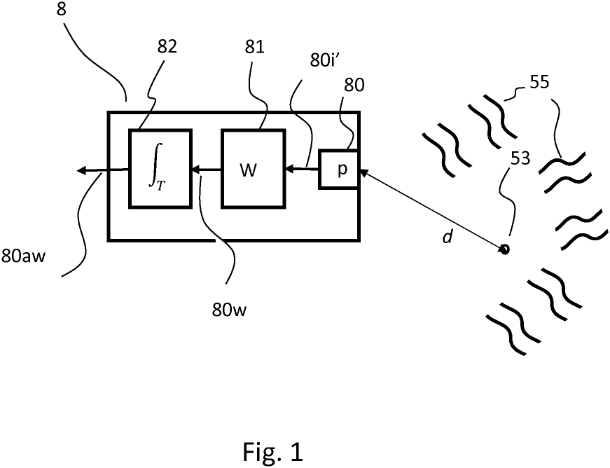

FIG. 1 shows schematically a prior apparatus and method of measuring sound pressure information related to noise. In FIG. 1, a noise source 53 like a mouth of a chimney generates noise 55. Audible sound like noise propagates as a sound wave that, in a medium like air, causes deviations in the local ambient pressure of the medium (static pressure) in the direction of the propagation of the sound wave. These deviations in the pressure of the medium are the so-called waves of sound or sound waves.

In the prior art equivalent noise level meter 8, for example a sound pressure sensor 80 is configured to receive noise 55 from the noise source 53 at a distance d and indicate the measured result as a direct sound pressure information 80i′ which can be an analogue voltage or current signal, or a digital signal based on sampling of the analogue signal. For sound related information having an audible range from approximately 20 Hz to 20 kHz, sound pressure measurement sampling is performed usually at a sampling rate of some tens of kHz, for example 48 kHz. Taking one digital sample of the sound pressure p is called a sound pressure measurement step. Sound pressure sensors are readily and commercially available in various sizes, interfaces, mountings, directional patterns etc.

Sound pressure level (SPL) L_{P} or acoustic pressure level can be represented as a logarithmic measure of the effective sound pressure p relative to a reference value p₀: L_{P} = 20 log₁₀ (p/p₀) dB (decibels). A commonly used reference value for sound pressure is 20 µPa which is the threshold of hearing for a healthy young person. This sound pressure level equals approximately to a noise of a mosquito in flight at distance of 2 - 4 meters, resulting in the baseline level of 0 dB for the sound pressure of 20 µPa.

Human sense of sound has a variable sensitivity to different audible frequencies, and sound also exists as infrasound and ultrasound below and above the audible range, respectively. Sense of hearing is most sensible to frequencies between 1 kHz and 6 kHz. Further, as already mentioned, it is not sensitive to frequencies above 20 kHz (ultrasounds) or below 20 Hz (infra-sounds). Thus, sound energy at these frequencies is not interpreted as noise, as it is not perceived by the sense of sound. To take the frequency dependency of sense of hearing into account, the sound pressure information is often weighted with frequency response information. A much-used and widely known weight is the so-called A-weighting which has a maximum weight at approximately 3 kHz and approximately 50 dB attenuation at the threshold of audible range of 20 Hz. Such weighting is readily performed for example with analogue electrical circuits or with corresponding digital circuitry or signal processing devices. Such devices are called weighting filters in the art, shown in FIG. 1 as a weighting filter unit 81. Noise emissions specifications usually stipulate on a weighting filter that is to be used. Possibilities are for example A-weighting filter, C-weighting filter or Z-weighting filter or any other such weighting filter. Weighting filter unit 81 may be configured to take direct sound pressure information 80i′ as input and generate output 80w called weighted sound pressure information. A-weighted sound pressure units are abbreviated dB(A) or dBA in the art. When acoustic measurements are being referred to, the units used will be stated in dB sound pressure levels referenced to the above mentioned 20 µPa, equal to 0 dB. A-weighting is often used for environmental noise measurements. For a A-weighted sound pressure level there is a relation L_{pA} = 20 log₁₀ (p_{A/}p₀) dB, where p_{A} is the A weighted value of p. Thus, for the purposes of present text, “weighting” of the sound pressure information means any purposeful change of spectral characteristics of the sound pressure information.

A so-called equivalent continuous sound level (for example A weighted as discussed here) can be defined as a time-average of the weighted sound pressure information defined as (below, T = t₂ - t₁):

$${L}_{A e q T} = 10 l o {g}_{10} \left(\frac{1}{T} {\int }_{t 1}^{t 2} {10}^{\frac{L p A \left(t\right)}{10}} d t\right) .$$

Stated differently, the value for A-weighted sound pressure information is integrated over the averaging time of T, and then divided by the averaging time T to arrive to an average value for L_{pA}, L_{AeqT} at the respective time interval. The averaging can be performed similarly for C-weighted or Z-weighted sound pressure information. The averaging can also be performed for a non-weighted, direct sound pressure information.

This integration of the sound pressure level information over time and the other related computations like division with the integration time T are readily performed with a digital circuitry, one or more programmable computers or other such electrical circuitry, denoted as integrator unit or time-averaging unit 82 in FIG. 1. Finally, integrator unit 82 is configured to give output 80aw denoted as averaged, weighted sound pressure information 80aw as the output of the equivalent noise level meter 8.

Information 80i′ (direct sound pressure information), 80w (weighted sound pressure information) and 80aw (averaged, weighted sound pressure information) and other such sound pressure related information are called jointly sound pressure information in the present application, as they all convey information of the sound pressure.

It is to be understood that direct sound pressure information 80i′, weighted sound pressure information 80w and averaged, weighted sound pressure information 80aw etc. can be represented with analogue or digital formats in the apparatuses and methods of the present application. Preferably the format is digital and based on sampling of the sound pressure information into a digital representation. Depending on the embodiment, sound pressure information 80i is represented with a single temporal value, for example p = p(t₀), or a list of sound pressure information over time at specific time points t₀, t₁... t_{N}, p = [p(t₀), p(t₁), p(tz),... p(t_{N})]. In the present application, also any distance related information or position information can mean both a single temporal value, or a list of values over time or other such index. Preferably distance related information is also represented in a digital format.

In the present application, distance determination means direct or indirect determination of distance between the sound pressure sensor and the noise source. In both cases, distance determinant information is indicative of the distance.

In direct determination, distance is measured between the sound pressure sensor and the noise source, generating the distance information directly for example with an ultrasound sensor.

In indirect distance determination, position information (for example by an inertial positioning system) of the sound pressure sensor having coordinates Rp is determined. Then, as part of the so-called distance determination step or outside the distance determination step, distance d may be computed with information of the noise source having coordinates Rn such that d = |Rp - Rn|, as Rp and Rn can be considered as three-dimensional or two-dimensional position vectors of some frame of reference. With three dimensions, both horizontal coordinates (position on the ground, for example X and Y coordinates) and a vertical coordinate (altitude above the ground, for example Z coordinate) can be presented.

If the noise source and the sound pressure sensor are in the essentially same distance from the ground (that is, their altitude or location in Z dimension is essentially the same), it is sufficient to determine the distances only in XY (latitude/longitude) directions.

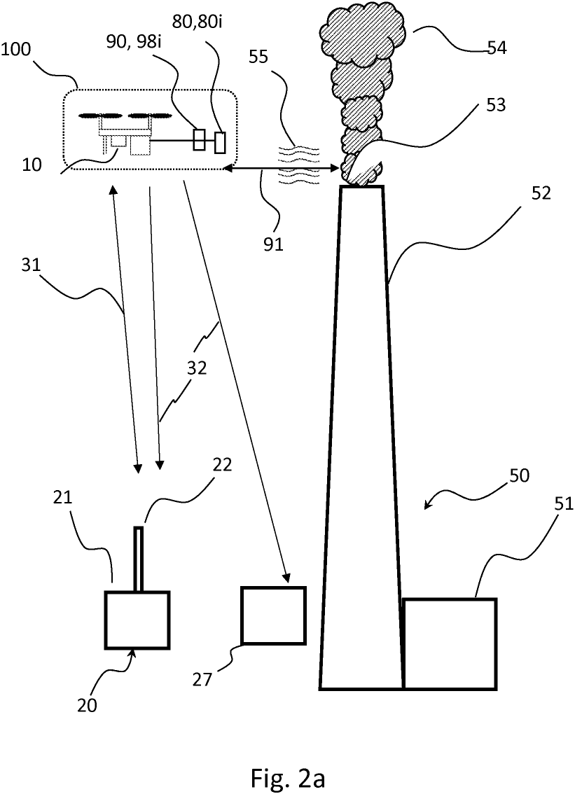

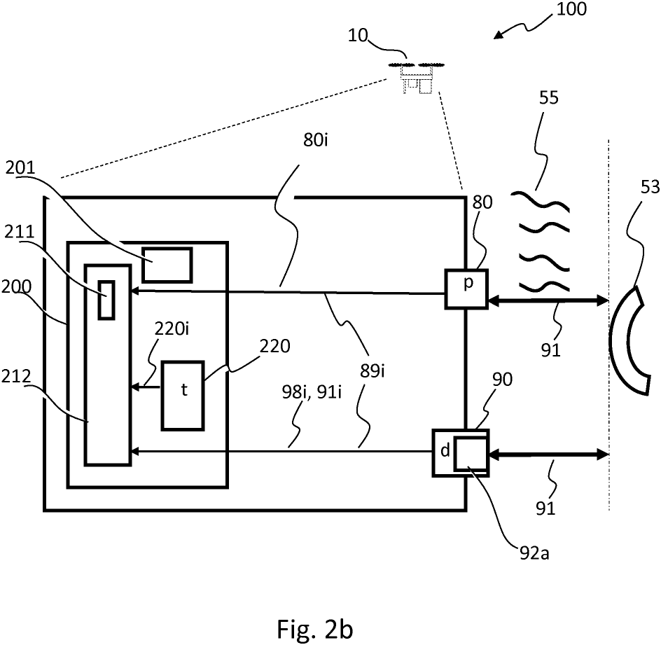

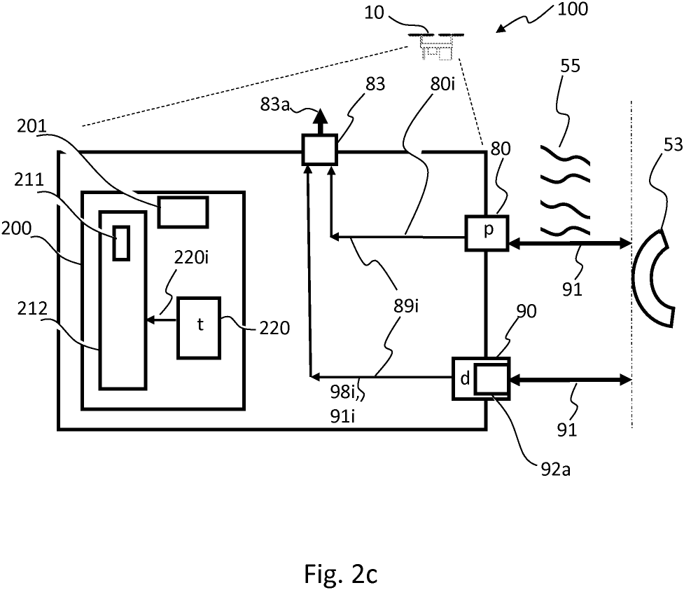

FIG. 2a shows an aspect of the present invention. In FIG. 2a, an unmanned aerial measurement apparatus 100 is provided for noise 55 measurement from a noise source 53. The unmanned aerial measurement apparatus 100 comprises an unmanned aerial vehicle 10, and a sound pressure sensor 80 configured to measure sound pressure information 80i from a noise source 53. In addition, the unmanned aerial measurement apparatus 100 comprises a distance determination unit 90, which is configured to determine distance determinant information 98i indicative of distance 91 between the noise source 53 and the sound pressure sensor 80.

FIG. 2a shows the unmanned aerial measurement apparatus 100 in operation close to a noise source 53, here a mouth of a chimney 52 of an industrial plant 50 that generates exhausts 54 from an industrial burning, vaporisation or melting process taking place inside a process building 51. Noise 55 emanates from a noise source 53 which is substantially the mouth or aperture at the upper end of the chimney 52 where exhaust flux hits the surrounding atmosphere, generating a turbulent flow regime emitting a noise with a very high sound pressure.

A remote-control unit 20 may be configured to control the flight of the drone 10 through a two-way wireless channel 31 and to receive measurement information from the performed measurements through another wireless channel 32 transmitted from the unmanned aerial measurement apparatus 100, both channels 31 and 32 operated for example through antenna 22 and antenna of the unmanned aerial measurement apparatus 100.

Alternatively or additionally, measurement information from the performed measurements through another wireless channel 32 is received by a measurement information reception unit 27.

In the present application, the distance determinant information 98i may be utilized to determine the distance 91 between the sound pressure sensor 80 and the noise source 53.

In the present application, the distance determinant information 98i may also be utilized to diminish error in the sound pressure information 80i caused by variation in the distance 91.

In the present application, the distance determinant information 98i may also be utilized to diminish a measurement error in the sound pressure information 80i caused by variation in the distance 91.

This disclosure may be generally considered also as a noise measurement device for noise 55 measurement from a noise source 53. The noise measurement device may comprise a sound pressure sensor 80 configured to measure sound pressure information 80i. The noise measurement device may further comprise a distance determination unit 90 (and 90P and 90PD defined later) configured to determine distance 91 between the noise source 53 and the sound pressure sensor 80 such that the noise measurement device is arranged as an embedded unit 1b into an unmanned aerial vehicle 10.

Alternatively, the noise measurement device is provided into a mission unit 1a comprising a coupler 19 to couple the mission unit 1a to an unmanned aerial vehicle 10.

Turning next to FIG. 2b, in an embodiment, the distance determinant information 98i comprises distance information 91i.

The distance determination unit 90 may comprise an ultrasound sensor, laser sensor, a LIDAR sensor, external distance measurement sensor, camera sensor, infrared sensor, microwave radar sensor or a millimeter wave radar sensor. Said sensors may be configured to measure the distance information 91i of distance 91 between the noise source 53 and the sound pressure sensor 80.

Still referring to FIG. 2b, the distance determination unit 90 is configured to determine the distance 91 and the related distance information 91i directly with a distance measurement.

The distance determinant information 98i comprises distance information 91i, and the distance determination unit 90 comprises an ultrasound sensor 92a configured to measure the distance information 91i between the noise source 53 and the sound pressure sensor 80.

The ultrasound sensor 92a may be configured to send ultrasonic signals towards the noise source, and further configured to detect the reflected signals and still further configured to compute, based on the known velocity of sound in the air, the distance 91 from the time of travel of the ultrasound signals to the noise source and back. In this computation, distance information 91i is generated. Thus, the ultrasound sensor (or ultrasound rangefinder) 92a is configured to measure distance 91 between the sound pressure sensor 80 and the noise source 53.

An ultrasound sensor is advantageous for measuring the distance information between the noise source and the sound pressure sensor when noise source is arranged to emit exhausts that disturb optical or radio wave based sensors such as laser sensors, LIDAR sensors, camera sensors, infrared sensors or radar sensors. A chimney exhaust opening is an example of a noise source which is arranged to emit exhausts.

It is evident that as the sound pressure sensor 80 and distance determination unit 90 may be placed close to each other (for example, some 5 cm -15 cm away) and substantially perpendicularly with relation to the direction to the noise source 53, measurement of distance 91 between the noise source 53 and the distance determination unit 90 also gives the same distance 91 between the noise source 53 and sound pressure sensor 80. Alternatively, if the sound pressure sensor 80 is placed at the end of an arm (not shown) protruding towards the noise source, the length of the arm is easily accounted for in the distance measurements by subtracting the length of the arm from the distance information.

Alternatively, the distance determination unit 90 can comprise a laser sensor (not shown). Laser sensor is configured to send pulses of laser light towards the noise source 53 and further configured to measure the time of travel of the pulse to the noise source 53 and back. Based on the time of travel and known velocity of light in air, the laser sensor is configured to compute and to measure the distance 91 and the related distance information 91i between the laser sensor and the noise source 53.

As a further alternative, the distance determination unit 90 comprises a LIDAR sensor (not shown). LIDAR sensor (also known as Light Direction and Ranging or Light Radar) is configured to send light pulses to various directions, also towards the noise source 53. LIDAR sensor is further configured to compute and to measure the distance 91 and the related distance information 91i to the noise source based on the time of travel of the light pulses.

As another alternative, the distance determination unit 90 comprises an external distance measurement sensor (not shown). In this case, distance 91 can be measured from an external unit (not shown) as an external distance measurement. In this case, the external unit is equipped to send distance information of distance 91 to the external distance measurement sensor, giving the distance information 91i. For example, the distance determination unit 90 can be carried in or with a first unmanned aerial vehicle 10, and the external unit can be carried in or with a second unmanned aerial vehicle 10.

As further alternatives, the distance determination unit 90 can comprise a microwave radar sensor or a millimeter wave radar sensor (not shown). Microwave radar sensor and millimeter wave radar sensors are configured to send radio waves or pulses towards the noise source and further configured to determine the time of travel to the noise source 53 and back. With the knowledge of the velocity of radio waves or pulses in the air, the microwave radar sensor or the millimeter wave radar sensor is configured to compute and to measure the distance 91 and distance information 91i between the microwave or millimeter wave radar sensor and the noise source 53.

As a further alternative, the distance determination unit 90 can comprise an infrared sensor that operates similarly to the microwave or millimeter wave radar sensor, but with infrared light instead of radio waves or pulses. Again, distance information 91i is generated.

Still as a further alternative, the distance determination unit 90 can comprise a camera sensor. Camera sensor operates for example like an autofocus lens system in cameras, based for example on pixel contrast differences. Again, distance information 91i is generated.

A yet another alternative, the distance determination unit 90 can comprise an inertial positioning system (not shown). Inertial positioning system comprises acceleration sensors measuring acceleration in three directions X, Y and Z accurately. By double integration over time, relative position of the system becomes known if the initial velocity and direction relative to the noise source is known. By knowing the relative direction to the noise source in three dimensional space (both azimuth and elevation which are possible to determine for example by approaching the noise source from a certain compass bearing and at a known altitude) and by performing a distance measurement at least once with the known azimuth and elevation to the noise source, the inertial positioning system can also be configured to determine distance information directly. In other words, the inertial positioning system is configured to compute and to measure the distance 91 and distance information 91i to the noise source based on information of initial distance, relative direction and velocity. Velocity is known for example by keeping the distance determination unit still or essentially still for a moment. Determination of the initial distance, relative direction and velocity for distance determination purposes with an inertial positioning system is called the relative initial position step. As said, this approach needs at least one direct determination or measurement of distance to the noise source.

In other words, sound pressure sensor 80 is configured to generate sound pressure information 80i through measuring the sound pressure of noise 55. Distance determination unit 90 is configured to generate distance information 91i through a direct measurement of distance 91.

Unmanned aerial measurement apparatus 100 may further comprise a computer 200, comprising a memory 212.

Still referring to FIG. 2b, in an embodiment, measurement information 89i comprises the sound pressure information 80i and the distance determinant information 98i, and the unmanned aerial measurement apparatus 100 further comprises a memory 212 for storing the measurement information 89i.

In an embodiment, instead of storing the information, the measurement information 89i comprises the sound pressure information 80i and the distance determinant information 98i, and the unmanned aerial measurement apparatus 100 comprises a transceiver 83 for transmitting the measurement information 89i to a remote-control unit 20.

In an embodiment, instead of storing the information, the measurement information 89i comprises the sound pressure information 80i and the distance determinant information 98i, and the unmanned aerial measurement apparatus 100 comprises a transceiver 83 for transmitting the measurement information 89i to a measurement information reception unit 27.

The unmanned aerial measurement apparatus 100 may also comprise any combination of a memory 212 for storing the measurement information 89i, a transceiver 83 for transmitting the measurement information 89i to a remote-control unit 20, or a transceiver 83 for transmitting the measurement information 89i to a measurement information reception unit 27.

Sound pressure information 80i and the distance determinant information 98i comprising distance information 91i are fed and stored to the memory 212 of a computer 200. Sound pressure sensor 80 and distance determination unit 90 are coupled to the computer 200 with suitable, preferably digital interfaces. In other words, unmanned aerial measurement apparatus 100 comprises a memory 212 for storing measurement information 89i comprising sound pressure information 80i and distance determinant information 98i. With the stored measurement information 89i it is possible to analyse the sound pressure information 80i and distance information 91i together after the measurement event.

Association between the sound pressure information 80i and distance determinant information 98i can be realized in various ways. As one alternative, computer 200 of unmanned aerial measurement apparatus 100 has a computer system clock 220 that generates time information 220i. Computer 200 is configured, through computer instructions 211, processed in a processor 201 and governing the operation of the computer 200, to store into the memory 212 time information 220i of the sound pressure information 80i that indicates when the time of feeding (that is, memory storage) of the sound pressure information 80i to the memory 212 took place. The time of the feeding is, with modern day digital technology, practically the same as the sound pressure information 80i measurement.

Similarly, computer 200 is configured, through computer instructions 211, processed in a processor 201 and governing the operation of the computer 200, to store into the memory 212 time information 220i of the distance information 91i that indicates when the time of feeding of the distance information 91i to the memory took place.

As a further embodiment, sound pressure sensor 80 can be configured to generate sound pressure information 80i through measuring the sound pressure of noise 55 repeatedly, at least two times. Practically, sound pressure information 80i is measured tens of thousands of times in one second. Similarly, distance determination unit 90 can be configured to generate distance information 91i through a direct measurement of distance 91, repeatedly, at least two times. Practically, in the embodiment, distance determinant information 98i that comprises distance information 91i is determined tens of times in one second.

As an aspect of the present invention, and referring back to FIG. 2a, a method for measuring noise is disclosed. The method comprises a sound pressure measurement step for measuring sound pressure information 80i from a noise source 53 with a sound pressure sensor 80. The method further comprises a distance determination step for determining distance determinant information 98i indicative of distance 91 between the noise source 53 and the sound pressure sensor 80. The sound pressure measurement step and the distance determination step are executed in an unmanned aerial measurement apparatus 100. The unmanned aerial measurement apparatus 100 comprises an unmanned aerial vehicle 10. The method also comprises controlling flight of the unmanned aerial measurement apparatus 100.

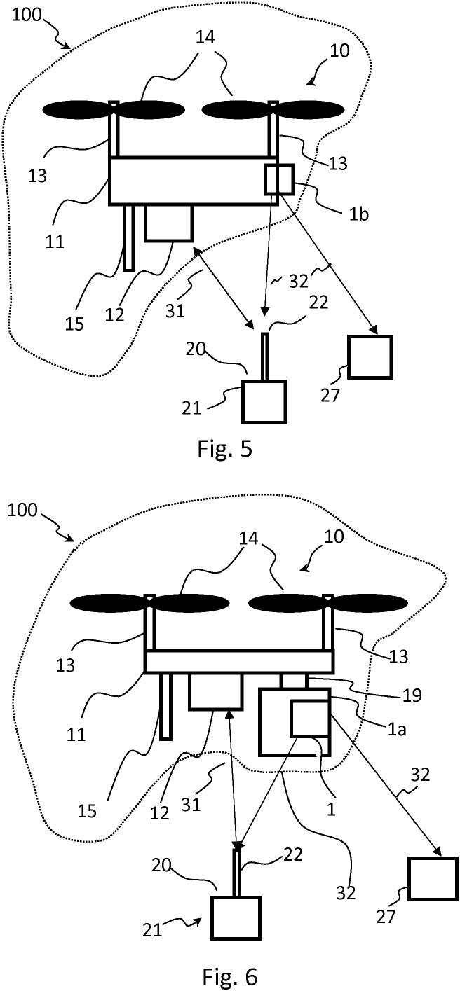

Details that the unmanned aerial vehicle 10 (also called “the drone 10”) may comprise are presented in FIGS. 5 and 6.

Controlling the flight of the unmanned aerial measurement apparatus 100 may be performed, for example, with a remote-control unit 20 that controls the unmanned aerial vehicle 10.

Controlling the flight of the unmanned aerial measurement apparatus 100 may be performed such that the unmanned aerial measurement apparatus 100 flies in the proximity of the noise source 53.

The method may comprise utilizing the distance determinant information 98i to determine the distance 91 between the sound pressure sensor 80 and the noise source 53.

The method may also comprise utilizing the distance determinant information 98i to diminish error caused by the distance variation in the sound pressure measurement step.

The method may also comprise utilizing the distance determinant information 98i to diminish error caused by the distance variation in the sound pressure information 80i.

In other words, the method may also comprise utilizing the distance determinant information 98i to diminish error in the sound pressure measurement step caused by variation in the distance 91.

Still in other words, the method may also comprise utilizing the distance determinant information 98i to diminish error in the sound pressure information 80i caused by variation in the distance 91.

This disclosure may be generally considered also as a method for measuring noise 55, the method comprising a sound pressure measurement step for measuring sound pressure information 80i from a noise source 53 with a sound pressure sensor 80. The method further comprises a distance determination step for determining distance 91 between the noise source 53 and the sound pressure sensor 80 such that the sound pressure measurement step and the distance determination step are executed in an embedded unit 1b arranged in an unmanned aerial vehicle 10.

This disclosure may be generally considered also as a method for measuring noise 55, the method comprising a sound pressure measurement step for measuring sound pressure information 80i from a noise source 53 with a sound pressure sensor 80. The method may further comprise a distance determination step for determining distance 91 between the noise source 53 and the sound pressure sensor 80 such that the sound pressure measurement step and the distance determination step are executed in the same mission unit 1a arranged to be coupled to an unmanned aerial vehicle 10.

In FIG. 2b, in an embodiment of the method, the distance determinant information 98i comprises distance information 91i.

In an embodiment of the method, the distance determination step comprises a distance measurement step generating the distance information 91i. Specifically, in FIG. 2b, the distance determination step comprises a direct distance determination step generating distance information 91i. In the distance measurement step, the distance 91 and the distance information 91i between the sound pressure sensor 80 and the noise source 53 is measured utilizing information from an ultrasound sensor 92a. The ultrasound sensor 92a is advantageous as it is not disturbed by particles or aerosols in the air, like chimney exhausts.

In an embodiment, in the distance measurement step, the distance 91 and the distance information 91i between the sound pressure sensor 80 and the noise source 53 may be measured utilizing information from a laser sensor, a LIDAR sensor, an external distance measurement sensor, a camera sensor, an infrared sensor, a microwave radar sensor or a millimeter wave radar sensor.

In an embodiment, the method comprises more than one sound pressure measurement steps and more than one distance determination steps. With many measurement needs, information from various distances is necessitated. It is also possible to compensate and time-average the sound pressure measurement results with multiple data points, making them more accurate in the process.

In an embodiment of the method, the sound pressure measurement step is executed at the rate of 10 kHz - 100 kHz, and the distance determination step is executed at the rate of 1 Hz - 50 Hz. Alternatively, the sound pressure measurement step is executed at the rate of 10 kHz - 100 kHz, and the distance determination step is executed at the rate of 50 Hz - 500 Hz. As a further alternative, the sound pressure measurement step is executed at the rate of 10 kHz - 100 kHz, and the distance determination step is executed at the rate of 500 Hz - 5 kHz.

Computer 200 may be configured to control the operation of sound pressure sensor 80 and distance determination unit 90 and the method steps related thereto.

Still referring to FIG. 2b, in an embodiment, the sound pressure information 80i and the distance information 91i are stored to a memory 212 in a distance related data storage step. As one alternative, a distance related data storage step is executed once for one sound pressure measurement step. Distance information may be stored based on the most recent distance measurement.

FIG. 2c depicts another embodiment of an unmanned aerial measurement apparatus 100 according to the invention. As in FIG. 2b, sound pressure sensor 80 is configured to generate sound pressure information 80i through measuring the sound pressure of noise 55 of a noise source 53. The distance determinant information 98i comprises distance information 91i. The distance determination unit 90 is configured to generate distance information 91i through a direct measurement of distance 91. Measurement information 89i comprises the sound pressure information 80i and the distance determinant information 98i.

Unmanned aerial measurement apparatus 100 comprises a transceiver 83 for transmitting measurement information 89i wirelessly to a remote-control unit 20 (shown in FIG. 2a) or to a measurement information reception unit 27 (shown in FIG. 2a) which is configured to receive a transmission from transceiver 83. Transceiver 83 comprises an antenna 83a for transmission and reception purposes.

Referring further to FIG. 2c, measurement information 89i comprising sound pressure information 80i and distance information 91i are transmitted with a transceiver 89i to a remote-control unit 20 (shown in FIG. 2a) or to a measurement information reception unit 27 (shown in FIG. 2a). In other words, as an embodiment of the present invention related to the method aspect, the method further comprises a distance related transmission step where sound pressure information 80i and distance information 91i are transmitted with a transceiver to a remote-control unit 20 or to a measurement information reception unit 27.

As an embodiment of the present invention related to the method aspect, the method may also comprise both a distance related data storage step where the sound pressure information 80i and the distance information 91i are stored to a memory 212, and a distance related transmission step where the sound pressure information 80i and the distance information 91i are transmitted with a transceiver 83 to a remote-control unit 20 or to a measurement information reception unit 27.

Symbols and units and their construction, purpose and function in FIG. 2c are otherwise the same as in FIG. 2b. Also in FIG. 2c, computer 200 can be used to control the operation of the sound pressure sensor 80 and distance determination unit 90 and the method steps related thereto.

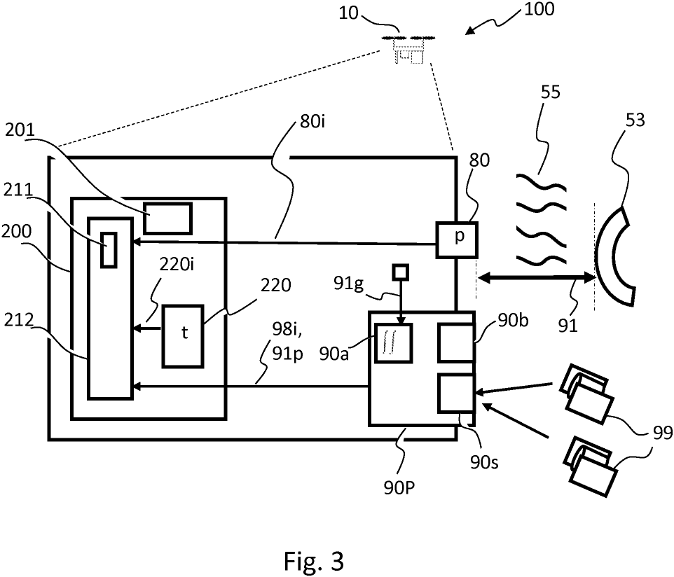

FIG. 3 shows another embodiment of the present invention, an unmanned aerial measurement apparatus 100 for noise measurement from a noise source 53, noise marked with symbol 55. The unmanned aerial measurement apparatus 100 comprises an unmanned aerial vehicle 10, a sound pressure sensor 80 configured to measure sound pressure information 80i from a noise source, and a distance determination unit 90P configured to determine distance determinant information 98i indicative of distance 91 between the noise source 53 and the sound pressure sensor 80. In the unmanned aerial measurement apparatus 100 of FIG. 3, the distance determination unit 90P is configured to determine the distance 91 “indirectly” with a sound pressure position measurement.

The distance determination unit 90P may comprise a satellite positioning system receiver 90s configured to determine the position of the sound pressure sensor 80 and, thus, configured to determine the sound pressure sensor position information 91p of the sound pressure sensor 80. The distance determinant information 98i may comprise the sound pressure sensor position information 91p.

The distance determination unit 90P may also comprise an inertial positioning system 90a configured to determine the position of the sound pressure sensor 80 and, thus, configured to determine the sound pressure sensor position information 91p of the sound pressure sensor 80. The distance determinant information 98i may comprise the sound pressure sensor position information 91p.

The distance determination unit 90P may also both a satellite positioning system receiver 90s and an inertial positioning system 90a both configured to determine the position of the sound pressure sensor 80 and, thus, configured to determine the sound pressure sensor position information 91p of the sound pressure sensor 80. The distance determinant information 98i may comprise the sound pressure sensor position information 91p.

The distance determination unit 90P may also comprise a barometric positioning 90b unit that determines altitude information to augment position information from a satellite positioning system receiver 90s or an inertial positioning system 90a, or position information both from a satellite positioning system receiver 90s and from an inertial positioning system 90a.

Satellite positioning system receiver 90s is part of a satellite positioning system (for example, the GPS system) that comprises satellites 99 in Earth orbit to determine longitude information and latitude information on the surface of the Earth, but also the height information or altitude information. In a three dimensional space, longitude can be considered as the X coordinate and latitude as the Y coordinate, and altitude as the Z coordinate. Naturally, also a spherical coordinate system with R, theta and phi coordinates can be used.

Inertial positioning system 90a comprises acceleration sensors measuring acceleration in three directions X, Y and Z accurately. Inertial positioning system 90a is configured to take initial position and velocity information 91g as input and determine the position information of the inertial position system by integrating acceleration over time to determine velocity information in X,Y and Z directions, and then integrating velocity information over time to determine the position information of the inertial positioning system. Initial position and velocity information 91g can be determined from information provided by satellite positioning system receiver 90s or entered through user interface by the user.

Barometric positioning unit 90b is configured to determine the altitude information relative to the ground level based on changes in the atmospheric pressure which is dependent on the altitude. Barometric positioning unit 90b is especially advantageous in making the altitude (Z) reading of a GPS positioning unit or inertial positioning unit more accurate in Z (altitude or height) dimension.

In the present application, augmenting position information or augmented position information means that for example for satellite-based positioning, horizontal information (XY) is determined with the satellite positioning system receiver 90s, and vertical or altitude information (Z) is determined with information from a barometric positioning unit 90b.

In other words, distance determination unit 90P comprises a satellite positioning system receiver 90s or an inertial positioning system 90a configured to determine the sound pressure sensor position information 91p of the sound pressure sensor 80. The distance determination unit 90P further comprises a barometric positioning unit 90b to augment the information of satellite or inertial systems.

In an embodiment, the distance determinant information 98i comprises sound pressure sensor position information 91p, and the distance determination unit 90, 90P, 90PD comprises a satellite positioning system receiver 90s configured to determine the sound pressure sensor position information 91p of the sound pressure sensor 80, and a barometric positioning unit 90b configured to augment the sound pressure sensor position information 91p.

In an embodiment, the distance determinant information 98i comprises sound pressure sensor position information 91p, and the distance determination unit 90, 90P, 90PD comprises an inertial positioning system 90a configured to determine the sound pressure sensor position information 91p of the sound pressure sensor 80, and a barometric positioning unit 90b configured to augment the sound pressure sensor position information 91p.

In an embodiment, the distance determinant information 98i comprises sound pressure sensor position information 91p, and the distance determination unit 90, 90P, 90PD comprises a both a satellite positioning system receiver 90s and an inertial positioning system 90a configured to determine the sound pressure sensor position information 91p of the sound pressure sensor 80, and a barometric positioning unit 90b configured to augment the sound pressure sensor position information 91p.

As the sound pressure sensor 80 and distance determination unit 90P may be placed close to each other (for example, some 5 cm - 15 cm away), position of the distance determination unit 90P is also indicated by the position information 91p of the sound pressure sensor 80 with good accuracy. Alternatively, if the sound pressure sensor 80 is placed at the end of an arm protruding towards the noise source, the length of the arm is easily accounted for in the distance measurements by subtracting the length of the arm from the distance information once the distance is computed from the position information.

Still referring to FIG. 3, as an embodiment of the method aspect of the present invention, the method comprises a sound pressure measurement step for measuring sound pressure information 80i. The distance determinant information 98i comprises sound pressure sensor position information 91p, and the distance determination step comprises a sound pressure sensor position determination step for determining sound pressure sensor position information 91p.

The distance determination step may generally comprise a sound pressure sensor 80 position determination step for determining sound pressure sensor position information 91p.

In an embodiment, the sound pressure sensor position determination step is executed utilizing information from a satellite positioning system receiver 90s.

In an embodiment, the sound pressure sensor position determination step is executed utilizing information from an inertial positioning system 90a.

Information from a satellite positioning system receiver 90s or an inertial positioning system 90a, or both from a satellite positioning system receiver 90s and an inertial positioning system 90a can be augmented with a barometric positioning unit 90b.

In other words, in an embodiment, the sound pressure sensor position determination step is executed utilizing information from a satellite positioning system receiver 90s, augmented with information from a barometric positioning unit 90b, or inertial positioning system 90a augmented with information from a barometric positioning unit 90b. Alternatively, the sound pressure sensor position determination step is executed utilizing information from a satellite positioning system receiver 90s and an inertial positioning system 90a, both augmented with information from a barometric positioning unit 90b, that is, both satellite positioning system receiver 90s and inertial positioning system 90a generated information is augmented with information from a barometric positioning unit 90b.

In an embodiment, the method comprises a position related data storage step for storing sound pressure information 80i and sound pressure sensor position information 91p to a memory 212.

In an embodiment, a position related data storage step may be executed once for one sound pressure measurement step. Sound pressure sensor position information may be stored based on the most recent sound pressure sensor position determination step.

In an embodiment, the sound pressure information 80i and the sound pressure sensor position information 91p may be transmitted outside the unmanned aerial measurement apparatus 100. In other words, as an embodiment of the present invention the method further comprises a position related transmission step where the sound pressure information 80i and the sound pressure sensor position information 91p are transmitted with a transceiver 83 (shown in FIG. 2c) to a remote-control unit 20 (as in FIG. 2a) or to a measurement information reception unit 27 (as in FIG. 2a).

In an embodiment, the method may comprise both a position related data storage step for storing the sound pressure information 80i and the sound pressure sensor position information 91p to a memory 212, and a position related transmission step where the sound pressure information 80i and the sound pressure sensor position information 91p are transmitted with a transceiver 83 to a remote-control unit 20 or to a measurement information reception unit 27.

Related to FIG. 3, the sound pressure measurement step is preferably executed at the rate of 10 kHz - 100 kHz, and the distance determination step is preferably executed at the rate of 1 Hz-50 Hz. Alternatively, the sound pressure measurement step is executed at the rate of 10 kHz - 100 kHz, and the distance determination step is executed at the rate of 50 Hz-500 Hz. As a further alternative, the sound pressure measurement step is executed at the rate of 10 kHz - 100 kHz, and the distance determination step is executed at the rate of 500 Hz-5kHz.

As above, computer 200 can be used to control the operation of sound pressure sensor 80 and distance determination unit 90P and the method steps related thereto.

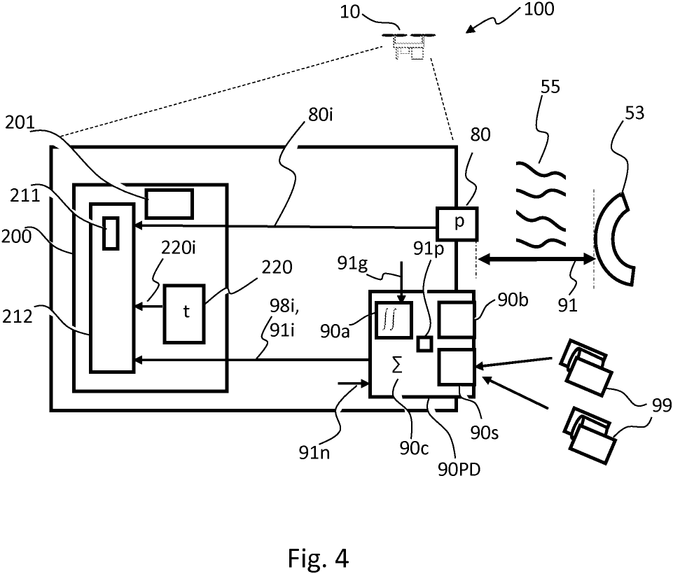

Referring next to FIG. 4, as an embodiment of the method according to the present invention, the distance determinant information 98i comprises sound pressure sensor position information 91p, and the distance determination step comprises a sound pressure sensor position determination step for determining sound pressure sensor position information 91p. The method further comprises a noise source position determination step for determining noise source 53 position information 91n. The distance determinant information 98i comprises also distance information 91i, and the distance determination step comprises a distance computation step for computing the distance information 91i from the sound pressure sensor position information 91p and from the noise source 53 position information 91n.

The sound pressure sensor position determination step may be executed in a distance determination unit 90PD.

The distance determination step may generally comprise a noise source position determination step for determining noise source 53 position information 91n, and a distance computation step for computing distance information 91i from the sound pressure sensor 80 position information 91p and the noise source 53 position information 91n.

Noise source position information 91n can be entered to the unmanned aerial measurement apparatus 100 through a user interface (not shown) or entered to the unmanned aerial measurement apparatus 100 through some other digital interface (not shown) in a noise source position input step, for example to the memory of the distance determination unit 90PD. After this, in a noise source position determination step (marked as 90c), noise source position information 91n may be read from the memory.

Computer 200 can be used to control and to implement the operation of sound pressure sensor 80 and distance determination unit 90PD and the method steps related thereto.

In an embodiment, the method comprises a distance related data storage step for storing sound pressure information 80i and sound pressure sensor position information 91i to a memory 212.

In an embodiment, the method comprises a noise source position (marked as 91n) determination step, and the distance determinant information 98i comprises noise source position information 91n.

In an embodiment, the method comprises distance related transmission step where the sound pressure information 80i and the distance information 91i are transmitted with a transceiver 83 to a remote-control unit 20 or to a measurement information reception unit 27.

In an embodiment, the method comprises both the distance related transmission step and a distance related data storage step.

Related to FIG. 4, the sound pressure sensor position determination step may be executed utilizing information from a satellite positioning system receiver 90s or an inertial positioning system 90a, or both.

A barometric positioning unit 90b generates advantageously information that may be used to augment information from a satellite positioning system receiver 90s or an inertial positioning system 90a related to the sound pressure sensor position determination step.

According to a further embodiment of the invention, in FIG. 5, unmanned aerial measurement apparatus 100 is provided for noise measurement from a noise source. The sound pressure sensor 80 and the distance determination unit 90, 90P, 90PD are arranged as an embedded unit 1b into the unmanned aerial vehicle 10 or drone 10.

The unmanned aerial vehicle 10 may comprise propellers 14 (or rotors 14). In Figure, the propellers 14 are shown in a side view, and two are shown. An unmanned aerial vehicle may have four propellers but any number of propellers like 3, 6 or 8 are possible for a controlled flight. Propellers are arranged to the unmanned aerial vehicle 10 to provide propulsion and aerodynamic lifting force to enable airborne operations of the unmanned aerial vehicle 10.

The unmanned aerial vehicle 10 may also comprise a body 11.

The body 11 may house at least one, some or most units of the unmanned aerial vehicle 10.

The unmanned aerial vehicle 10 may also comprise landing gears 15 (only one shown), propeller axes 13 for power transmission and a power and control unit 12.

Power and control unit 12 may comprise controllers (not shown) to control the flight events and flight parameters of the unmanned aerial vehicle like attitude, orientation, speed and altitude etc. Power and control unit may comprise also energy storage like one or more electrical batteries supplying the controls and motors of the unmanned aerial vehicle with energy needed in the operation. Power and control unit 12 may comprise further transmitter and receiver and related coding units for control signal modulation, reception and transmission (not shown) and an antenna (not shown) for communicating wirelessly with suitable radio technologies with a remote-control unit 20, utilizing wireless communications protocols. Body 11 may comprise also motors (not shown) for driving the propellers.

As shown in FIG. 5, the remote-control unit 20 may comprise a main body 21 and an antenna 22 for control signal 31 reception and transmission from and to the drone 10. Remote-control unit 20 may further comprise a user interface (not shown) with various actuators, levers and buttons or a touchscreen to control the flight parameters like horizontal and vertical speed, heading, altitude and attitude (for example roll, pitch and yaw) of the drone.

Advantageously, the drone 10 may also comprise a flight camera for viewing the flight path of the drone 10. User interface of the remote-control unit 20 may also present a view of the flight camera of the drone that transmits information of the flight events and objects in front of the drone 10. Said view also aids in performing the noise measurement, for example in holding a certain bearing, orientation, and altitude for the drone. View of the flight camera may be transmitted to the remote-control unit 20 via wireless channel 31.

Wireless channel 31 may be operated through antenna 22 and antenna of the drone 10. Wireless channel 32 is operated through antenna 22 and antenna of unmanned aerial measurement apparatus 100 (not shown). Alternatively, measurement information from the performed measurements through wireless channel 32 may be transceived via the antenna of the drone 10 (in power and control unit 12) to either to the remote-control unit 20 or to a measurement information reception unit 27 equipped with necessary radio devices and other data processing units (not shown).

Drone may further comprise a body 11, landing gears 15 (only one shown), propellers 14 (in a side view, two are shown; usually drone has four propellers but any number of propellers like 3, 6 or 8 are possible for controlled flight), propeller axes 13 for power transmission and a power and control unit 12. Power and control unit 12 comprises controllers (not shown) to control the flight events and flight parameters of the drone like attitude, orientation, speed and altitude etc. Power and control unit comprises also energy storage like one or more electrical batteries supplying the controls and motors of the drone with energy needed in the operation. Power and control unit 12 comprises further transmitter and receiver and related coding units for control signal modulation, reception and transmission (not shown) and an antenna (not shown) for communicating wirelessly with suitable radio technologies with a remote-control unit 20, utilizing wireless communications protocols. Body 11 comprises also motors (not shown) for driving the propellers.

Remote-control unit 20 comprises a main body 21 and an antenna 22 for control signal 31 reception and transmission from and to the drone 10. Remote-control unit 20 further comprises a user interface (not shown) with various actuators, levers and buttons or a touchscreen to control the flight parameters like horizontal and vertical speed, heading, altitude and attitude (for example roll, pitch and yaw) of the drone. Advantageously, user interface of the remote-control unit 20 comprises also a view of the camera of the drone that transmits information of the flight events and objects in front of the drone. Said view also aids in performing the noise measurement, for example in holding a certain bearing, orientation, and altitude for the drone.

Wireless channel 31 is operated through antenna 22 and antenna of the drone 10. Wireless channel 32 is operated through antenna 22 and antenna of unmanned aerial measurement apparatus 100 (not shown). Alternatively, measurement information from the performed measurements through wireless channel 32 is transceived via the antenna of the drone 10 (in power and control unit 12) to either to the remote-control unit 20 or to a measurement information reception unit 27 equipped with necessary radio devices and other data processing units (not shown).

Still referring to FIG. 5, as an embodiment of the method according to the present invention, the sound pressure measurement step and the distance determination step are executed in an embedded unit 1b arranged in an unmanned aerial vehicle 10.

According to a further embodiment of the invention, in FIG. 6, unmanned aerial measurement apparatus 100 is provided for noise measurement from a noise source. The sound pressure sensor 80 and the distance determination unit 90, 90P, 90PD are arranged into a mission unit 1a comprising a coupler 19 to couple the mission unit 1a to the unmanned aerial vehicle 10. Thus, in FIG. 6, the unmanned aerial measurement apparatus 100 comprises a mission unit 1a. Mission unit 1a comprises a coupler 19 to couple the mission unit 1a to an unmanned aerial vehicle 10. Other units and symbols in FIG. 6 correspond to those of FIG. 5.

Still referring to FIG. 6, as a further embodiment of the method according to the present invention, the sound pressure measurement step and the distance determination step are executed in the same mission unit 1a arranged to be coupled with a coupler 19 to the unmanned aerial vehicle 10.

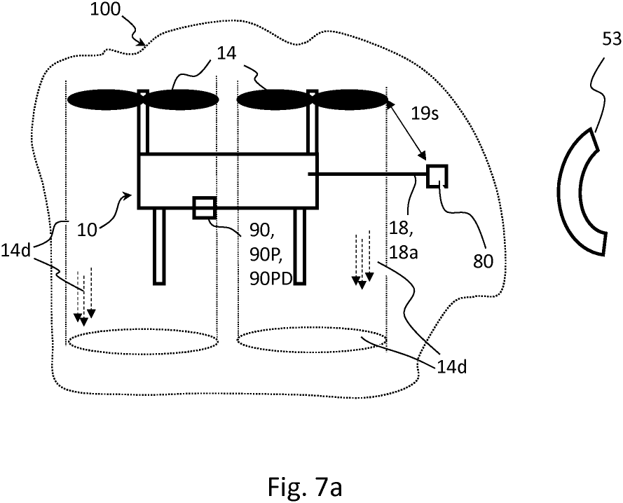

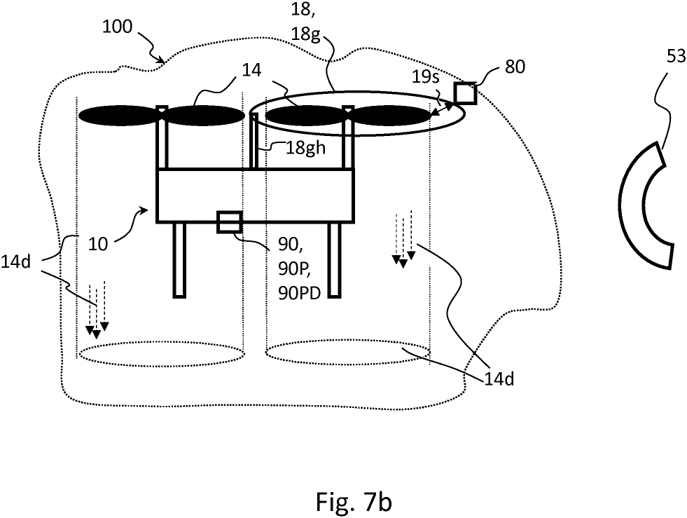

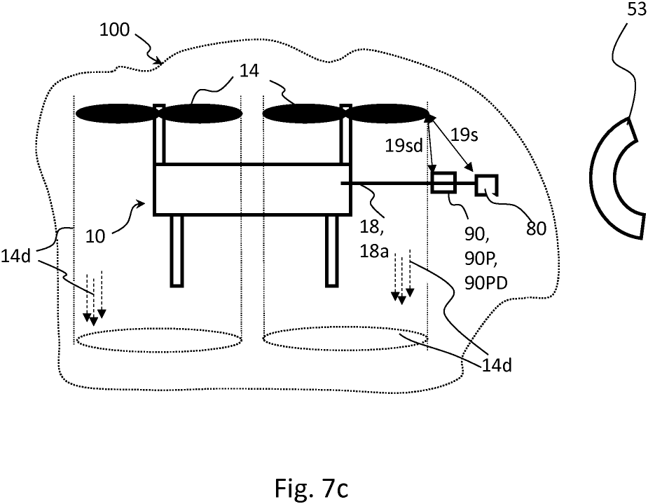

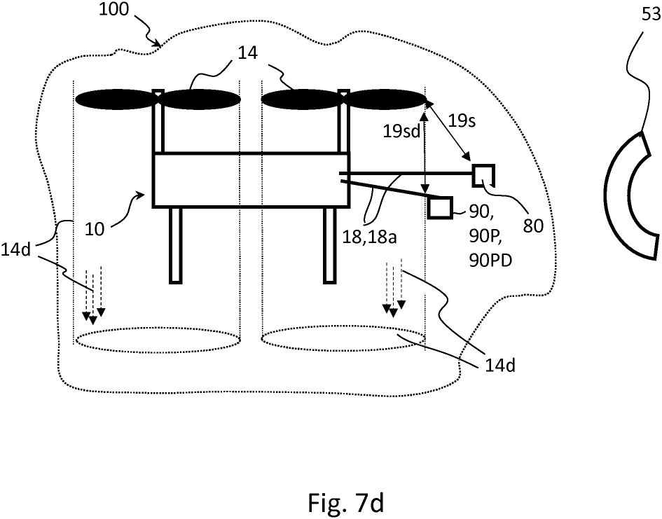

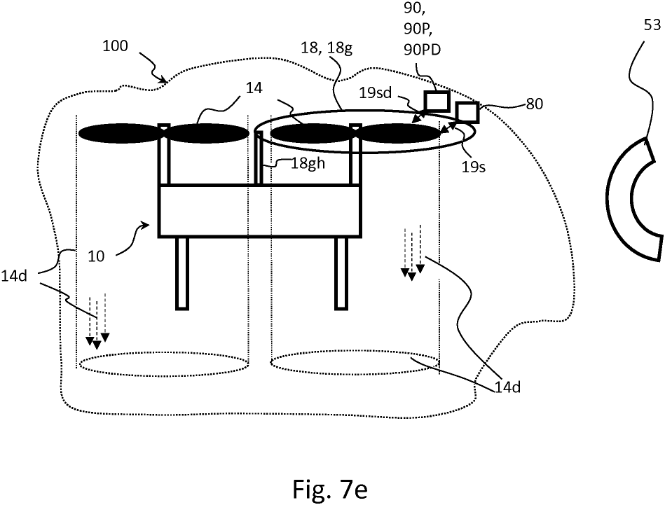

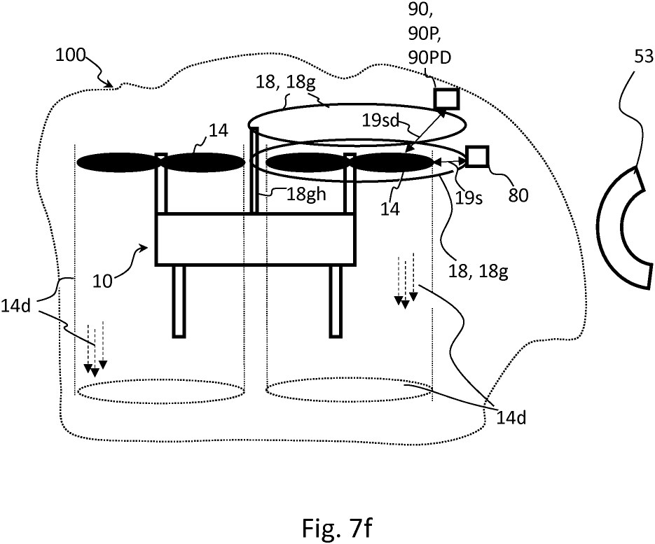

Referring to FIG. 7a, in an embodiment, the unmanned aerial vehicle 10 comprises propellers 14, and the unmanned aerial measurement apparatus 100 comprises an appendage 18 arranged to provide separation 19s from the propellers 14 of the unmanned aerial vehicle 10. Further, the appendage 18 is connected to the unmanned aerial vehicle 10, and the sound pressure sensor 80 is connected to the appendage 18 such that the sound pressure sensor 80 is separated 19s from the propellers 14 of the unmanned aerial vehicle 10 with the appendage 18.

Referring to FIG. 7a, in an embodiment, the unmanned aerial vehicle 10 comprises propellers 14, and the unmanned aerial measurement apparatus 100 comprises an appendage 18 arranged to provide separation 19s from the propellers 14 of the unmanned aerial vehicle 10. The appendage 18 is connected to the unmanned aerial vehicle 10, and the sound pressure sensor 80 is connected to the appendage 18 such that a closest separation 19s between each of the propellers 14 of the unmanned aerial vehicle 10 and the sound pressure sensor 80 is at least 10 cm.

The closest separation 19s is the separation or distance between the sound pressure sensor 80 and one of the blades of the closest propeller 14 to the sound pressure sensor 80, when the propeller 14 is turned to an angle so that the distance of the tip of the propeller 14 is the closest separation distance.

Referring still to FIG. 7a the unmanned aerial vehicle 10 comprises propellers 14, the unmanned aerial measurement apparatus 100 comprises an appendage 18 arranged to provide separation 19s from the propellers 14 of the unmanned aerial vehicle 10. The appendage 18 is connected to the unmanned aerial vehicle 10, and the sound pressure sensor 80 is connected to the appendage 18 such that the sound pressure sensor 80 is located outside the area of downwash 14d of the propellers 14.

For the purposes of this text, “downwash” is the airstream or airstreams generated by the propellers 14 that provides the lifting and propulsive force to unmanned aerial vehicle 10 to enable airborne operation of the unmanned aerial vehicle 10.

The appendage 18 may be any mechanical part with the capacity to provide separation relative to the propellers 14 outside a body 11 of the unmanned aerial vehicle 10.

Related to FIG. 7a, in an embodiment, the appendage 18 comprises a longitudinal arm 18a.

The longitudinal arm 18a may be a long and narrow stick or a stick-like object, or a hollow longitudinal tube. The longitudinal arm 18a may comprise one or more bends or corners in the longitudinal direction. The longitudinal arm 18a may comprise, for example, plastic, fiberglass or metal, for example aluminium.

Related to FIG. 7b, in an embodiment, the appendage 18 comprises a propeller guard 18g. A propeller guard 18g is arranged to guard one or more of the propellers 14 from hitting the surroundings of the one or more propellers 14 when the propellers 14 rotate.

The propeller guard 18g may comprise, for example, a strip-like barrier around the perimeter of the one or more propellers 14.

The propeller guard 18g may be fastened or connected to the unmanned aerial vehicle 10 with a guard support 18gh.

The propeller guard 18g and the guard support 18gh may comprise, for example, plastic, fiberglass or metal, for example aluminium.

In an embodiment, the appendage 18 may comprise both a longitudinal arm 18a and a propeller guard 18g.

The arm 18a and the propeller guard 18g may be arranged such that the arm 18a is fastened to the propeller guard 18g and the arm 18a extends from the propeller guard outwards relative to the one or more propellers 14 guarded by the propeller guard 18g.

Referring next to FIGS. 7c-7f, in an embodiment, the unmanned aerial vehicle 10 comprises propellers 14, and the unmanned aerial measurement apparatus 100 comprises one or more appendages 18 arranged to provide separation 19s, 19sd from the propellers 14 of the unmanned aerial vehicle 10. The one or more appendages 18 are connected to the unmanned aerial vehicle 10. The sound pressure sensor 80 and the distance determination unit 90, 90P, 90PD are connected to the one or more appendages 18, and the sound pressure sensor 80 and the distance determination unit 90, 90P, 90PD are separated, marked with 19s, 19sd, from the propellers 14 of the unmanned aerial vehicle 10 with the one or more appendages 18.

Referring still to FIGS. 7c-7f, in an embodiment, the unmanned aerial vehicle 10 comprises propellers 14, and the unmanned aerial measurement apparatus 100 comprises one or more appendages 18 arranged to provide separation 19s, 19sd from the propellers 14 of the unmanned aerial vehicle 10. The one or more appendages 18 are connected to the unmanned aerial vehicle 10. The sound pressure sensor 80 and the distance determination unit 90, 90P, 90PD are connected to the one or more appendages 18. The sound pressure sensor 80 and the distance determination unit 90, 90P, 90PD are separated with separations 19s and 19sd from the propellers 14 of the unmanned aerial vehicle 10 with the one or more appendages 18 such that a closest separation 19s between each of the propellers 14 of the unmanned aerial vehicle 10 and the sound pressure sensor 80 is at least 10 cm, and a closest separation 19sd between each of the propellers 14 of the unmanned aerial vehicle 10 and the distance determination unit 90, 90P, 90PD is at least 10 cm.

Referring still to FIGS. 7c-7f, in an embodiment, the unmanned aerial vehicle 10 comprises propellers 14, and the unmanned aerial measurement apparatus 100 comprises one or more appendages 18 arranged to provide separation marked with 19s, 19sd from the propellers 14 of the unmanned aerial vehicle 10. The one or more appendages 18 are connected to the unmanned aerial vehicle 10. The sound pressure sensor 80 and the distance determination unit 90, 90P, 90PD are connected to the one or more appendages 18. The sound pressure sensor 80 and the distance determination unit 90, 90P, 90PD are separated from the propellers 14 of the unmanned aerial vehicle 10 with the one or more appendages 18 such that the sound pressure sensor 80 is located outside the area of downwash 14d of the propellers 14, and such that the distance determination unit 90, 90P, 90PD is located outside the area of downwash 14d of the propellers 14.

Related to FIGS. 7c and 7d, in an embodiment, the one or more appendages 18 comprise a longitudinal arm 18a.

Related to FIGS. 7e and 7f, in an embodiment, the one or more appendages 18 comprise a propeller guard 18g.

In an embodiment, one or more appendages 18 may comprise both a longitudinal arm 18a and a propeller guard 18g, arranged such that both the arm 18a and the propeller guard 18g are fastened to the unmanned aerial vehicle 10.

The closest separation 19s is the separation or distance between the sound pressure sensor 80 and one of the blades of the closest propeller 14 to the sound pressure sensor 80, when the propeller 14 is turned to an angle so that the distance of the tip of the propeller 14 is the closest separation distance.

The closest separation 19sd is the separation or distance between the distance determination unit 90, 90P, 90PD and one of the blades of the closest propeller 14 to the distance determination unit 90, 90P, 90PD, when the propeller 14 is turned to an angle so that the distance of the tip of the propeller 14 is the closest separation distance 19sd.

Advantage of the embodiments related to FIGS. 7a-7f and the appendage 18 is that sound pressure sensor 80 is disturbed by the noise of the drone 10 less when separated from the drone 10, the more separated, the better. For a very long separation, imbalance caused by the long separation may hamper flight of the drone 10.

Similarly, some distance determination units, especially the ultrasound sensor, are disturbed by the noise of the drone 10, and especially of the downwash 14d and the noisy flow of air lifting and propulsing the drone 10. For the drone 10, downwash 14d is inevitable as it is the flow of air from the propellers that keeps the drone 10 airborne. Thus, it is advantageous to locate also the distance determination unit 90, 90P, 90PD with a separation from the unmanned aerial vehicle 10. In particular, it is advantageous to locate the distance determination unit 90, 90P, 90PD outside the area of downwash 14d when the distance determination unit 90, 90P, 90PD comprises an ultrasound sensor configured to measure the distance information 91i between the noise source 53 and the sound pressure sensor 80.

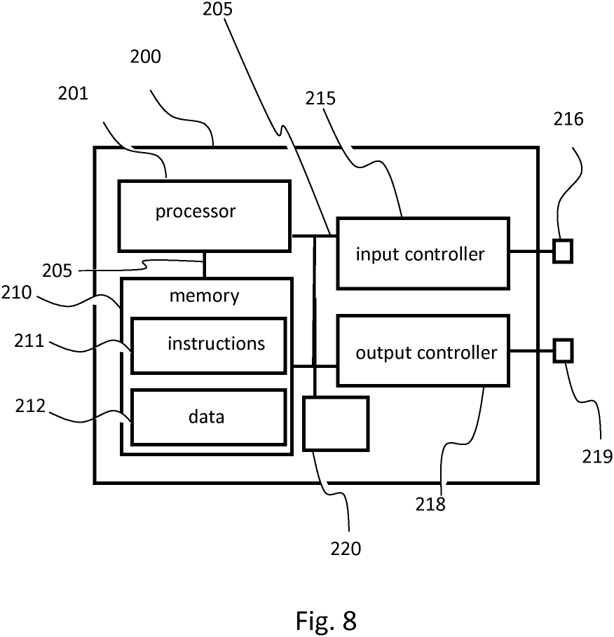

FIG. 8 shows a digital computer 200 advantageous in various aspects of the present invention. Computer 200 comprises a digital microprocessor or a controller like a microcontroller, herein called a processor 201, configured to move digital information through the communication bus 205 of the computer and perform various operations to the information. Processor 201 reads instructions to be performed from the instruction portion 211 of the digital memory 210. Processor 201 is further configured read and write data to and from the memory 212 based on the instructions from memory portion 211 that command the processor. Digital memory is either volatile (meaning that memory loses its state when electricity supply is cut off) or non-volatile (meaning that the memory maintains its state even with no electricity supply). Volatile memory types are for example RAM memory like SRAM or DRAM. Non-volatile memory types are for example ROM, PROM, EEPROM memory, optical memory, magnetic memory and flash memory. Input and output controller 215 and 218, respectively, are dedicated digital electronics units configured to perform input and output to the computer through input interface 216 and output interface 219. One or more instructions are also called a computer program through which computer 200 is readily configured to perform various data or information processing tasks. There can be many such programs in the memory, which are executed in a determined order also governed by a control program, often called an operating system. Processor 201 is also configured to control the communication bus 205 to move information in the computer 200. With a computer program, computer 200 is also configured to perform operations depending on the input received through the input interface 216. Computer system clock 220 is used for generating time information and to synchronize the various digital operations of the computer 200.

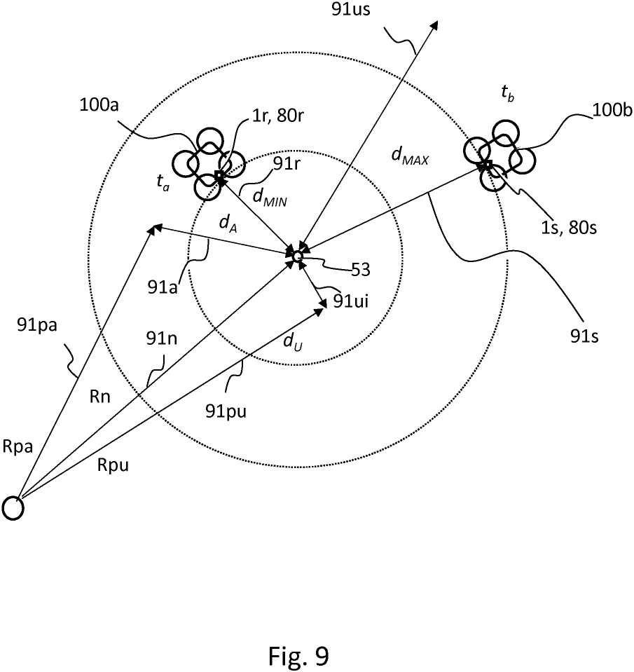

FIG. 9 shows an embodiment of a method according to the invention, a vertical view of the unmanned aerial measurement apparatus 100a, 100b circling at essentially level flight (that is, maintaining the same altitude) a point-like noise source 53. Unmanned aerial measurement apparatus 100 is shown at two different timepoints tₐ and t_{b} . The method comprises an acceptance determination step in which the sound pressure information 80i is accepted if the distance 91 between the noise source 53 and the sound pressure sensor 80r, 80s is between a range of a minimum allowable distance 91r (d_{MIN}) and a maximum allowable distance 91s (d_{MAX}) during a sound pressure information 80i measurement step, and discarded (that is, not accepted) if the distance 91 between the noise source 53 and the sound pressure sensor 80r, 80s is outside the range of a minimum allowable distance 91r (d_{MIN}) and a maximum allowable distance 91s (d_{MAX}) during the sound pressure measurement step. The distance 91 may be based on the distance determinant information 98i.

An example of a distance 91 where the sound pressure information is accepted is shown with distance arrow 91a. Examples of distances where the sound pressure information is discarded (that is, not accepted) are shown with distance arrow 91us and 91ui. In reality, the situation is three-dimensional, but for clarity, only a planar, two-dimensional view is shown.

Determining values for d_{MIN} and d_{MAX} depends on the allowable tolerance for the measurement error due to the variations in measurement distance, relative to some standard measurement distance d₀. For example, assuming a Lₑᵣᵣ = ±1,5 dB tolerance in the measurement error, we have for a maximum distance an attenuation factor of 10C^{(-1.5dB/20)}=0.841, and for minimum distance, 10^{(1.5dB/20)} = 1.189. Assuming a measurement distance of d₀ = 2 m, we have a minimum distance of d_{MIN} 2m*0.841=1,68 m, and maximum distance of d_{MAX} = 2 m*1.189 = 2.38 m.

Thus, formulas for minimum and maximum distances are:

$${d}_{\text{MIN}} = {d}_{0} \times {10}^{\left(- L \text{err/20}\right)} \text{and}$$

$${d}_{\text{MAX}} = {\text{d}}_{0} \times {10}^{\left(L \text{err/20}\right)} .$$

It is to be noted that values for d_{MIN} and d_{MAX} are not symmetrical around d₀.

Thus, still referring to FIG. 9, the method may comprise a step of determining a minimum allowable distance and a maximum allowable distance.

Minimum and maximum allowable distances can also be determined by noise source position 91n and sound pressure sensor position 91pa, 91pu. As an example, a distance where the sound pressure information is accepted is shown with distance arrow 91a. This distance 91 d is determined by the noise source position 91n (stated as position vector Rn) and the sound pressure sensor position 91pa (stated as position vector Rpa) as d_{A} = |Rpa - Rn|, that is the length of the vector of the subtraction of Rpa and Rn. The same holds for an example position where the sound pressure information is discarded, with distance d_{U} = |Rpu - Rn|.

The acceptance determination step can also be performed based on an allowable sound pressure sensor position information 91pal which holds the positions for the sound pressure sensor that are within the minimum and maximum allowable distance. The sound pressure information is accepted if the sound pressure sensor position 91n is within the allowable sound pressure sensor position information 91pal, and discarded, if the sound pressure sensor position 91n is not within the allowable sound pressure sensor position information 91pal.

Thus, distance 91 related to the acceptance determination step may be determined based on the distance determinant information 98i.

The acceptance determination step is an example of the method utilizing the distance determinant information 98i to diminish error in the sound pressure measurement step caused by variation in the distance 91.

In other words, the acceptance determination step is an example of the method utilizing the distance determinant information 98i to diminish error in the sound pressure information 80i caused by variation in the distance 91.

Still referring to FIG. 9, as another embodiment of a method according to the invention, the method comprises a triggering step that executes a sound pressure measurement step when the distance 91 between the noise source 53 and the sound pressure sensor 80 is between the range of a minimum allowable distance 91r and a maximum allowable distance 91s, and leaves a sound pressure measurement step unexecuted when the distance 91 between the noise source 53 and the sound pressure sensor 80 is outside the range of a minimum allowable distance 91r and a maximum allowable distance 91s. An example of a distance where the sound pressure measurement is triggered to be executed is shown with distance arrow 91a. Examples of distances where the sound pressure information is not triggered and left unexecuted are shown with distance arrow 91us and 91ui. Distance 91 may be determined from the distance determinant information 98i.

The triggering step is an example of the method utilizing the distance determinant information 98i to diminish error in the sound pressure measurement step caused by variation in the distance 91.

In other words, the triggering step is an example of the method utilizing the distance determinant information 98i to diminish error in the sound pressure information 80i caused by variation in the distance 91.

The condition for the triggering step can also be determined by noise source position 91n and sound pressure sensor position 91pa, 91pu. As an example, a distance 91 where the sound pressure information measurement is triggered to be executed is shown with distance arrow 91a. This distance 91 d_{A} is determined by the noise source position 91n (stated as position vector Rn) and the sound pressure sensor position 91pa (stated as position vector Rpa) as d_{A} = |Rpa -Rn|, that is the length of the vector of the subtraction of Rp and Rn in some three dimensional space. The same holds for an example position where the sound pressure information is left unexecuted, with distance dᵤ = |Rpu - Rn|. Thus, again, distance 91 may be determined from the distance determinant information 98i.

Thus, distance 91 related to the triggering step may be determined based on the distance determinant information 98i.

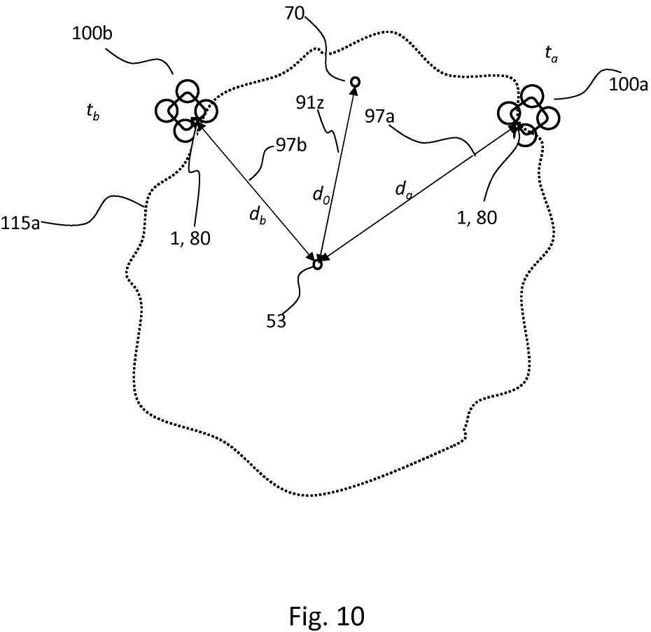

According to an embodiment of the method of the present invention, FIG. 10 shows a vertical view of the unmanned aerial measurement apparatus 100a, 100b circling at essentially level flight a point-like noise source 53 at two different timepoints tₐ and t_{b} along a path 115a. Sound pressure sensor 80 in an unmanned aerial measurement apparatus 100 are also shown in two positions. The noise source 53 is located high above the ground and suspended there by a supporting structure (not shown). At tₐ, the unmanned aerial measurement apparatus 100 is at distance dₐ shown with double arrow 97a, and at t_{b}, at distance d_{b} shown with double arrow 97b. Double arrow 91z denotes distance from a noise source 53 to a point 70 which may be governed to be the measurement point of a noise measurement according to a noise regulation and/or measurement standard d₀ or other such reference value, or a reference distance for example related to such a standard.

Positioning the unmanned aerial measurement apparatus 100 in a stationary way to the measurement point 70 is difficult owing to the typically gusty and strong winds high above ground levels. Variations in the flight path are denoted with the undulating nature of the path 115a. If the unmanned aerial measurement apparatus 100 was commanded to hover still in the air with no movement, it would randomly move around a central point even in modest wind conditions. This movement causes considerable error to the sound pressure measurements that are potentially to be made at a fixed, accurate distance, which may be stipulated by a standard.

It is well established in the laws of physics that sound pressure from a point-like source follows ideally the inverse square law in terms of distance. If the distance increases by a fluctuating measurement position, the sound pressure decreases, and vice versa. Error produced by the fluctuating measurement position can be rectified by compensation.

Thus, according to an embodiment of the method of the present invention, the method further comprises a compensation step for compensating the sound pressure information with a compensation model arranged to generate compensated sound pressure information, compensation being based on the distance 91 between the noise source 53 and the sound pressure sensor 80.

In other words, in an embodiment of the method of the present invention, the method further comprises a compensation step for compensating the sound pressure information 80i with a compensation model, compensation being based on the distance determinant information 98i indicative of the distance 91 between the noise source 53 and the sound pressure sensor 80.

In other words, the compensation step is based on the distance determinant information 98i indicative of the distance 91 between the noise source 53 and the sound pressure sensor 80.

The compensation step is another example of the method utilizing the distance determinant information 98i to diminish error in the sound pressure measurement step caused by variation in the distance 91.

In other words, the compensation step is an example of the method utilizing the distance determinant information 98i to diminish error in the sound pressure information 80i caused by variation in the distance 91.

The method may generally comprise a compensation step for compensating the sound pressure information with a compensation model arranged to generate compensated sound pressure information, compensation being based on the distance information 91i between the noise source 53 and the sound pressure sensor 80.

In other words, the compensation step may be based on the distance information 91i between the noise source 53 and the sound pressure sensor 80.

The method may generally comprise a compensation step for compensating the sound pressure information with a compensation model arranged to generate compensated sound pressure information, compensation being based on distance 91 between the noise source 53 and the sound pressure sensor 80.

In other words, the compensation step is based on the distance 91 between the noise source 53 and the sound pressure sensor 80.

Compensation is variation of the measured sound pressure information according to a rule, for example a mathematical rule with a multiplier. For a point-like noise source following inverse square law, such a multiplier is (dₐ / d₀)². For example, the sound pressure information p(tₐ) at time tₐ and with distance dₐ there is a multiplier (dₐ / d₀)². With this multiplier, compensated sound pressure information pc at distance dₐ and time t is pc(tₐ)= p(tₐ) (dₐ / do)² . Similarly, at t_{b} and d_{b},pc(t_{b})= p(t_{b}) (d_{b}/ d₀)².

Thus, in an embodiment, the compensation model is an inverse square law pc = p * (d / do)² in which p is the sound pressure information 80i prior to compensation, pc is the compensated sound pressure information, d is the distance 91 indicated by the distance determinant information 98i and d₀ is a reference distance that may be set, for example, by a noise standard. * is a multiplication operator.

In another embodiment, the compensation model is an inverse law pc = p * (d / d₀) in which p is the sound pressure information 80i prior to compensation, pc is the compensated sound pressure information, d is the distance 91 indicated by the distance determinant information 98i and d₀ is a reference distance that may be set, for example, by a noise standard. * is a multiplication operator.

In another embodiment, the compensation model is an inverse law pc = p * f(d) in which p is the sound pressure information 80i prior to compensation, pc is the compensated sound pressure information, d is the distance 91 indicated by the distance determinant information 98i and f(d) is a monotonously increasing function of d. * is a multiplication operator.

Computations related to the compensation and other values relevant to the measurement may be performed in a computer 200 (described in conjunction with FIG. 8) or by a computer of the remote-control unit 20 or the measurement information reception unit 27 (as for example in FIG. 2a) into which the measurement information 89i is transferred. Alternatively, respective units of the unmanned aerial measurement apparatus 100 may be provided with digital hardware to perform the necessary computations based on well-known art of digital electronics.

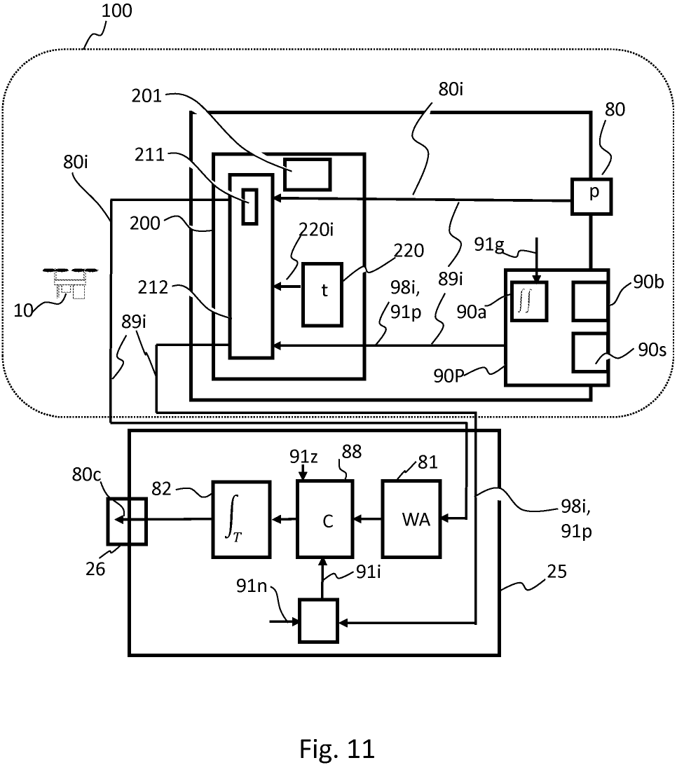

According to an embodiment of the present invention, FIG. 11 shows that for example the distance computation step and the compensation step can be executed in a unit outside the unmanned aerial measurement apparatus 100, for example in the remote-control unit 20 or any other computer unit like measurement information reception unit 27. As in FIG. 3, in FIG. 11, distance determination step comprises a sound pressure sensor position determination step for determining sound pressure sensor position information 91p. Distance determinant information 98i comprises the sound pressure sensor position information 91p. The sound pressure sensor position determination step is executed utilizing information from a satellite positioning system receiver 90s or an inertial positioning system 90a, possibly augmented with information from a barometric positioning unit 90b. Further, the method comprises a position related data storage step for storing sound pressure information 80i and sound pressure sensor position information 91p to a memory 212.

After the measurement event (for example, flying the unmanned aerial measurement apparatus 100 around a noise source 53 with unmanned aerial measurement apparatus 100 in operation), the measurement information 89i (comprising sound pressure information 80i, and distance determinant information 98i comprising sound pressure sensor position information 91p) is read from the memory 212 of the unmanned aerial measurement apparatus 100 and then transferred through an interface (not shown) in a measurement data transfer step to a computing unit 25 through the interface of the computing unit 25 (interface not shown). In FIG. 11, there is a noise source position determination step for determining the noise source position information 91n in the computing unit 25. Noise source position information 91n can be entered to computing unit 25 through a user interface 26, for example a keyboard or a touch screen, or measured and transferred to computing unit 25 with a satellite positioning system receiver (not shown) in a noise source position input step, for example to the memory of the computing unit 25. After this, in a noise source position determination step, noise source position information 91n is read from the memory. With the sound pressure sensor position information 91p and noise source position information 91n, computing unit 25 computes, in a distance computation step, the distance information 91i from the sound pressure sensor position information 91p and the noise source 53 position 91n information.

Thus, in an embodiment, the method may comprise a noise source position determination step for determining noise source 53 position information 91n. The distance determinant information 98i comprises distance information 91i, and the method comprises a distance computation step for computing the distance information 91i from the sound pressure sensor 80 position information 91p and from the noise source 53 position information 91n.

In general, the method may comprise providing noise source 53 position information 91n.

Sound pressure information 80i, also transferred from the unmanned aerial measurement apparatus 100 into the computing unit 25 through an interface, is first weighted in at least one weighting step. This is shown with conjunction with a weighting unit 81. Weighted sound pressure information is then compensated in at least one compensation step, shown in FIG. 11 as a compensation unit 88, for compensating the sound pressure information with a compensation model arranged to generate compensated sound pressure information. Compensation is based on distance determinant information 98i comprising, in this embodiment, the distance information 91i between the noise source 53 and the sound pressure sensor 80. Computation of the compensation is made with inverse square law, by multiplying the weighted sound pressure information from unit 81 with multiplier (d/ do)² where d is the distance information 91i, and d₀ is a reference distance information 91z entered into the computing unit 25 for example through a user interface 26.

After compensation, the method further comprises at least one time-averaging step wherein the sound pressure information is time-averaged using weighted and compensated sound pressure information. Time-averaging is performed for example for a time of 1-50 seconds, preferably for 5-25 seconds, and most preferably 5-15 seconds. Time-averaging is performed in a time-averaging unit 82. Alternatively, time-averaging is performed for 15-25 seconds.

If sound pressure information 80i is available at a sample rate of for example 40 kHz (40 000 samples in one second) and distance information 91i at a rate of 10 Hz (ten samples in one second), distance information needed for compensation may be interpolated for the sound pressure information samples having no direct association in the distance information (here, direct association means, for example, that they would be taken at exactly the same time).

Finally, computing unit 25 provides output of the sound pressure information in an output step 80c, for example to the user interface 26 of the computing unit 25.

It is also possible to perform the steps above with a different order. For example, it is possible to have the weighting step for the compensated sound pressure information, that is, after the compensation step. In this case, compensated and weighted sound pressure information is generated for the time-averaging step. It is also possible to perform the steps above without the weighting step. In this case, compensated sound pressure information is generated for the time-averaging step.

Thus, in an embodiment, the method comprises a time-averaging step after the compensation step wherein the sound pressure information is time averaged after the compensation step.

In another an embodiment, the method comprises a weighting step after the compensation step wherein the sound pressure information is weighted after the compensation step.

In yet another an embodiment, the method comprises a time-averaging step before the compensation step wherein the sound pressure information is time averaged before the compensation step.

In yet another an embodiment, the method comprises a weighting step before the compensation step wherein the sound pressure information is weighted before the compensation step.

The method may generally comprise a time averaging step wherein the sound pressure information is time averaged using compensated sound pressure information, weighted and compensated sound pressure information, or compensated and weighted sound pressure information.

Computing unit 25 is a digital computing unit, arranged for example as the computer 200 explained in relation to FIG. 8, configured to compute, input and output digital information and specifically implement the method steps indicated in conjunction with FIG. 11.

The signal processing units of weighting unit 81, compensation unit 88 and time-averaging unit 82 can naturally be arranged directly in an unmanned aerial measurement apparatus 100, too. In other words, in an embodiment, unmanned aerial measurement apparatus 100 comprises a weighting unit 81, a compensation unit 88 and a time-averaging unit 82 to store in memory 212 directly the compensated, compensated and weighted, or weighted and compensated sound pressure information.

As another embodiment, unmanned aerial measurement apparatus 100 comprises a weighting unit 81, a compensation unit 88, a time-averaging unit 82, and a transceiver (not shown) for transmitting the compensated, compensated and weighted, or weighted and compensated sound pressure information to a remote-control unit (not shown) or to a measurement information reception unit (not shown).

The invention has been described above with reference to the examples shown in the figures. However, the invention is in no way restricted to the above examples but may vary within the scope of the claims.

1-24. (canceled)

25. A method for measuring noise, comprising a sound pressure measurement step for measuring sound pressure information from a noise source with a sound pressure sensor, wherein
the method further comprises a distance determination step for determining distance determinant information indicative of distance between the noise source and the sound pressure sensor,
the sound pressure measurement step and the distance determination step are executed in an unmanned aerial measurement apparatus, the unmanned aerial measurement apparatus comprising an unmanned aerial vehicle, and
the method further comprises controlling flight of the unmanned aerial measurement apparatus.

26. The method according to claim 25, wherein the distance determinant information comprises sound pressure sensor position information, and the distance determination step comprises a sound pressure sensor position determination step for determining the sound pressure sensor position information.

27. The method according to claim 26, wherein
the method further comprises a noise source position determination step for determining noise source position information, and
the distance determinant information comprises distance information, and
the distance determination step comprises a distance computation step for computing the distance information from the sound pressure sensor position information and from the noise source position information.

28. The method according to claim 26, wherein one of:
the sound pressure sensor position determination step is executed utilizing information from a satellite positioning system receiver;
the sound pressure sensor position determination step is executed utilizing information from an inertial positioning system;
the sound pressure sensor position determination step is executed utilizing information from a satellite positioning system receiver and an inertial positioning system;
the sound pressure sensor position determination step is executed utilizing information from a satellite positioning system receiver augmented with information from a barometric positioning unit;
the sound pressure sensor position determination step is executed utilizing information from an inertial positioning system augmented with information from a barometric positioning unit; or
the sound pressure sensor position determination step is executed utilizing information from a satellite positioning system receiver and information from inertial positioning system, information from a satellite positioning system receiver and information from inertial positioning system both augmented with information from a barometric positioning unit.

29. The method according to claim 26, wherein the method further comprises one of:
a position related data storage step for storing the sound pressure information and the sound pressure sensor position information to a memory;
a position related transmission step where the sound pressure information and the sound pressure sensor position information are transmitted with a transceiver to a remote-control unit or to a measurement information reception unit; or
both a position related data storage step for storing the sound pressure information and the sound pressure sensor position information to a memory, and a position related transmission step where the sound pressure information and the sound pressure sensor position information are transmitted with a transceiver to a remote-control unit or to a measurement information reception unit.

30. The method according to claim 25, wherein the distance determinant information comprises distance information, and the distance determination step comprises a distance measurement step generating the distance information wherein the distance information between the sound pressure sensor and the noise source is measured by utilizing information from any of the following sensors:
an ultrasound sensor,
a laser sensor,
a LIDAR sensor,
a external distance measurement sensor,
a camera sensor,
an infrared sensor,
a microwave radar sensor, or
a millimeter wave radar sensor.

31. The method according to claim 27, wherein in the method further comprises at least one of:
a distance related data storage step where the sound pressure information and the distance information are stored to a memory; and/or
a distance related transmission step where the sound pressure information and the distance information are transmitted with a transceiver to a remote-control unit or to a measurement information reception unit.

32. The method according to any one of claims 25, wherein the sound pressure measurement step is executed in the sound pressure sensor, and the distance determination step is executed in a distance determination unit such that the sound pressure sensor and the distance determination unit are arranged as an embedded unit into an aerial vehicle or into a mission unit comprising a coupler to couple the mission unit to the aerial vehicle.

33. The method according to claim 25, wherein the method comprises more than one sound pressure measurement steps and more than one distance determination steps.

34. The method according to claim 25, wherein one of:
the sound pressure measurement step is executed at the rate of 10 kHz - 100 kHz, and the distance determination step is executed at the rate of 1 Hz -50 Hz;
the sound pressure measurement step is executed at the rate of 10 kHz - 100 kHz, and the distance determination step is executed at the rate of 50 Hz -500 Hz; or
the sound pressure measurement step is executed at the rate of 10 kHz - 100 kHz, and the distance determination step is executed at the rate of 500 Hz -5 kHz.

35. The method according to claim 25, wherein the method further comprises an acceptance determination step in which the sound pressure information is:
accepted if the distance between the noise source and the sound pressure sensor is between a range of a minimum allowable distance and a maximum allowable distance during the sound pressure measurement step, and
discarded if the distance between the noise source and the sound pressure sensor is outside a range of a minimum allowable distance and a maximum allowable distance during the sound pressure measurement step.

36. The method according to claim 25, wherein the method further comprises a triggering step that
executes the sound pressure measurement step when the distance between the noise source and the sound pressure sensor is between a range of a minimum allowable distance and a maximum allowable distance, and
leaves the sound pressure measurement step unexecuted when the distance between the noise source and the sound pressure sensor is outside a range of a minimum allowable distance and a maximum allowable distance.

37. The method according to claim 25, wherein the method further comprises a compensation step for compensating the sound pressure information with a compensation model, compensation being based on the distance determinant information indicative of the distance between the noise source and the sound pressure sensor.

38. The method according to claim 37, wherein the method further comprises one of:
a time-averaging step after the compensation step wherein the sound pressure information is time averaged after the compensation step;
a weighting step after the compensation step wherein the sound pressure information is weighted after the compensation step;
a time-averaging step before the compensation step wherein the sound pressure information is time averaged before the compensation step; or
a weighting step before the compensation step wherein the sound pressure information is weighted before the compensation step.

39. An unmanned aerial measurement apparatus for noise measurement from a noise source, wherein the unmanned aerial measurement apparatus comprises:
an unmanned aerial vehicle,
a sound pressure sensor configured to measure sound pressure information from a noise source, and
a distance determination unit configured to determine distance determinant information indicative of distance between the noise source and the sound pressure sensor.

40. The unmanned aerial measurement apparatus according to claim 39, wherein the sound pressure sensor and the distance determination unit are arranged:
as an embedded unit into the unmanned aerial vehicle; or
into a mission unit comprising a coupler to couple the mission unit to the unmanned aerial vehicle.

41. The unmanned aerial measurement apparatus according to claim 39, wherein the unmanned aerial vehicle comprises propellers, the unmanned aerial measurement apparatus comprises an appendage arranged to provide separation from the propellers of the unmanned aerial vehicle and one of:
the appendage is connected to the unmanned aerial vehicle, and the sound pressure sensor is connected to the appendage such that the sound pressure sensor is separated from the propellers of the unmanned aerial vehicle with the appendage;
the appendage is connected to the unmanned aerial vehicle, and the sound pressure sensor is connected to the appendage such that a closest separation between each of the propellers of the unmanned aerial vehicle and the sound pressure sensor is at least 10 cm; or
the appendage is connected to the unmanned aerial vehicle, and the sound pressure sensor is connected to the appendage such that the sound pressure sensor is located outside the area of downwash of the propellers.

42. The unmanned aerial measurement apparatus according to claim 39, wherein the unmanned aerial vehicle comprises propellers, the unmanned aerial measurement apparatus comprises one or more appendages arranged to provide separation from the propellers of the unmanned aerial vehicle, the one or more appendages being connected to the unmanned aerial vehicle, the sound pressure sensor and the distance determination unit being connected to the one or more appendages, and one of:
the sound pressure sensor and the distance determination unit are separated from the propellers of the unmanned aerial vehicle with the one or more appendages;
the sound pressure sensor and the distance determination unit are separated from the propellers of the unmanned aerial vehicle with the one or more appendages such that a closest separation between each of the propellers of the unmanned aerial vehicle and the sound pressure sensor is at least 10 cm, and a closest separation between each of the propellers of the unmanned aerial vehicle and the distance determination unit is at least 10 cm; or
the sound pressure sensor and the distance determination unit are separated from the propellers of the unmanned aerial vehicle with the one or more appendages such that the sound pressure sensor is located outside the area of downwash of the propellers, and the distance determination unit is located outside the area of downwash of the propellers.

43. The unmanned aerial measurement apparatus according to claim 41, wherein one of:
the appendage comprises a longitudinal arm;
the appendage comprises a propeller guard; or
the appendage comprises both a longitudinal arm and a propeller guard.

44. The unmanned aerial measurement apparatus according to claim 39, wherein the distance determinant information comprises sound pressure sensor position information, and the distance determination unit comprises one of:
a satellite positioning system receiver configured to determine the sound pressure sensor position information of the sound pressure sensor;
an inertial positioning system configured to determine the sound pressure sensor position information of the sound pressure sensor; or
both a satellite positioning system receiver and an inertial positioning system configured to determine the sound pressure sensor position information of the sound pressure sensor.

45. The unmanned aerial measurement apparatus according to claim 39, wherein the distance determinant information comprises sound pressure sensor position information, and the distance determination unit comprises one of:
a satellite positioning system receiver configured to determine the sound pressure sensor position information of the sound pressure sensor, and a barometric positioning unit configured to augment the sound pressure sensor position information;
an inertial positioning system configured to determine the sound pressure sensor position information of the sound pressure sensor, and a barometric positioning unit configured to augment the sound pressure sensor position information; or
both a satellite positioning system receiver and an inertial positioning system configured to determine the sound pressure sensor position information of the sound pressure sensor, and a barometric positioning unit configured to augment the sound pressure sensor position information.

46. The unmanned aerial measurement apparatus according to claim 39, wherein the distance determinant information comprises distance information, and the distance determination unit comprises a laser sensor, a LIDAR sensor, an external distance measurement sensor, a camera sensor, an infrared sensor, a microwave radar sensor, or a millimeter wave radar sensor configured to measure the distance information between the noise source and the sound pressure sensor.

47. The unmanned aerial measurement apparatus according to claim 39, wherein the distance determinant information comprises distance information, and the distance determination unit comprises an ultrasound sensor configured to measure the distance information between the noise source and the sound pressure sensor.

48. The unmanned aerial measurement apparatus according to claim 39, wherein measurement information comprises the sound pressure information and the distance determinant information, and the unmanned aerial measurement apparatus further comprises at least one of:
a transceiver for transmitting the measurement information to a remote-control unit;
a transceiver for transmitting the measurement information to a measurement information reception unit; and/or
a memory for storing the measurement information.
